(19) United States
(12) Patent Application Publication
(10) Pub. No.: US 2020/0387973 A1
(43) Pub. Date: Dec. 10, 2020

(54) RESTRICTED-ACCESS CREDIT DEVICE

(71) Applicant: HealthCare PayCard, LLC, Richardson, TX (US)

(72) Inventors: Jeffery Christian Blankinship, Plano, TX (US); Paul Edwards Clampitt, Plano, TX (US)

(21) Appl. No.: 16/583,132

(22) Filed: Sep. 25, 2019

Related U.S. Application Data
(60) Provisional application No. 62/857,990, filed on Jun. 6, 2019.

(51) Int. Cl. G06Q 40/08; G06Q 20/40; G06Q 20/24; G06Q 30/02; G06Q 30/06

(52) U.S. Cl. CPC G06Q 40/08; G06Q 20/405; G06Q 30/0631; G06Q 30/0238; G06Q 20/24

(57) ABSTRACT

Techniques are described herein that are capable of restricting access to a line of credit associated with a restricted-access credit device. For instance, the restricted-access credit device may receive a purchase request that requests execution of a purchase transaction for an item from a point-of-sale terminal. The purchase request includes a merchant category code of a merchant that is associated with the point-of-sale terminal. The item includes good(s) and/or service(s). The restricted-access credit device may provide an account identifier that identifies the line of credit to the point-of-sale terminal. The restricted-access credit device may cause the merchant category code of the merchant to be cross-referenced with healthcare-related merchant category codes. The restricted-access credit device may selectively trigger execution of the purchase transaction depending on whether the merchant category code of the merchant corresponds to at least one of the healthcare-related merchant category codes.

### CROSS-REFERENCE TO RELATED APPLICATION(S)

This application claims the benefit of U.S. Provisional Patent Application No. 62/857,990 (Atty Docket No. H01.00010000), entitled “Restricted-Access Credit Card,” filed Jun. 6, 2019, which is incorporated herein by reference in its entirety.

### BACKGROUND

Over the past decade, much of the burden of paying for healthcare has shifted from employers to employees, and the costs for healthcare have increased substantially. For instance, such costs may relate to insurance deductibles, copayments (a.k.a. co-pays), medical procedures, medicines, preventative tests, and medical examinations. People may not have funds immediately available to cover these costs. Accordingly, the people may choose to delay or forego healthcare expenditures, which may negatively affect their health. For example, some people are unable to afford their insurance deductibles until many months (e.g., six months) into the year of coverage. In another example, some people wait for a major medical expense to take place before trying to get funding for such an expense.

### SUMMARY

Various approaches are described herein for, among other things, restricting access to a line of credit associated with a restricted-access credit device. A restricted-access credit device is a credit device that controls whether purchase transactions are executed depending on whether merchant category codes of merchants associated with the purchase transactions are healthcare-related merchant category codes. The terms “merchant category code” and “healthcare-related merchant category code” are discussed in further detail below. If the merchant category code of the merchant associated with a purchase transaction is a healthcare-related merchant category code, the restricted-access credit device may allow the purchase transaction to be executed, assuming that any other criteria are also satisfied. If such other criteria are not satisfied, the restricted-access credit device may not allow the purchase transaction to be executed (e.g., may prevent the purchase transaction from being executed). If the merchant category code of the merchant associated with a purchase transaction is not a healthcare-related merchant category code, the restricted-access credit device may not allow the purchase transaction to be executed. A credit device is a device with which a line of credit is associated to enable a user to whom the line of credit is granted to pay a merchant for goods and/or services by using the line of credit. The credit device is issued to the user by an issuer based at least in part on a promise by the user to pay the issuer for charges applied against the line of credit.

A merchant category code (MCC) is a number (e.g., four-digit number) identified in the ISO 18245 standard, which pertains to retail financial services. A merchant category code is assigned to a business to indicate the types of goods and/or services that the business provides (e.g., sells). For instance, a committee of issuers (e.g., MasterCard, Visa, American Express, Diners Club, and Discover) may create the merchant category codes to be used by merchants who use the payment infrastructure of any one or more of the issuers for purchase transactions. A healthcare-related merchant category code is a merchant category code that indicates that the types of goods and/or services that a business provides are healthcare-related goods and/or healthcare-related services. Examples of a healthcare-related merchant category code include but are not limited to the following: “4119” which pertains to ambulance services; “5047” which pertains to dental, lab, medical, and ophthalmic hospital equipment and supplies; “5122” which pertains to drugs, drug proprietaries, and druggists sundries; “5912” which pertains to drug stores and pharmacies; “5975” which pertains to hearing aids sales, service, and supply stores; “5976” which pertains to orthopedic goods and artificial limbs stores; “7277” which pertains to debt, marriage, and personal counseling service; “8011” which pertains to doctors not elsewhere classified; “8021” dentists and orthodontists; “8031” which pertains to osteopathic physicians; “8041” which pertains to chiropractors; “8042” which pertains to optometrists and ophthalmologists; “8043” which pertains to opticians, optical goods, and eyeglasses; “8049” which pertains to chiropodists and podiatrists; “8050” which pertains to nursing and personal care facilities; “8062” which pertains to hospitals; “8071” which pertains to dental and medical laboratories; “8099” which pertains to health practitioners and medical services not elsewhere classified; and “6300” which pertains to insurance sales, underwriting, and premiums. These example healthcare-related merchant category codes are provided for non-limiting illustrative purposes. For example, additional healthcare-related merchant category codes may be identified in the ISO 18245 standard in the future, and the embodiments described herein are intended to encompass such healthcare-related merchant category codes. In another example, a format of the merchant category codes (including the healthcare-related merchant category codes) may change in the future (e.g., to include one or more additional digits), and the embodiments described herein are intended to encompass such format changes.

In an example approach, a restricted-access credit device includes memory and processor(s) coupled to the memory. The processor(s) are configured to communicate with a point-of-sale terminal by providing an account identifier that identifies a line of credit associated with the restricted-access credit device to the point-of-sale terminal and further by receiving a purchase request that requests execution of a purchase transaction for an item from the point-of-sale terminal. The purchase request includes a merchant category code of a merchant that is associated with the point-of-sale terminal. The item includes good(s) and/or service(s). The processor(s) are further configured to cause the merchant category code of the merchant to be cross-referenced with healthcare-related merchant category codes. The processor(s) are further configured to selectively trigger execution of the purchase transaction depending on whether the merchant category code of the merchant corresponds to at least one of the healthcare-related merchant category codes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 shows an example restricted-access credit system in accordance with an embodiment.

FIG. 2 depicts a flowchart of an example method for restricting access to a line of credit associated with a restricted-access credit device in accordance with an embodiment.

FIG. 3 depicts a flowchart of an example method for selectively adding additional credit to a line of credit associated with a restricted-access credit device in accordance with an embodiment.

FIG. 4 is a block diagram of an example restricted-access credit device in accordance with an embodiment.

FIG. 5 is a system diagram of an example mobile device in accordance with an embodiment.

FIG. 6 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

### II. Example Embodiments

Example embodiments described herein are capable of restricting access to a line of credit associated with a restricted-access credit device. A restricted-access credit device is a credit device that controls whether purchase transactions are executed depending on whether merchant category codes of merchants associated with the purchase transactions are healthcare-related merchant category codes. The terms “merchant category code” and “healthcare-related merchant category code” are discussed in further detail below. If the merchant category code of the merchant associated with a purchase transaction is a healthcare-related merchant category code, the restricted-access credit device may allow the purchase transaction to be executed, assuming that any other criteria are also satisfied. If such other criteria are not satisfied, the restricted-access credit device may not allow the purchase transaction to be executed (e.g., may prevent the purchase transaction from being executed). If the merchant category code of the merchant associated with a purchase transaction is not a healthcare-related merchant category code, the restricted-access credit device may not allow the purchase transaction to be executed. A credit device is a device with which a line of credit is associated to enable a user to whom the line of credit is granted to pay a merchant for goods and/or services by using the line of credit. The credit device is issued to the user by an issuer based at least in part on a promise by the user to pay the issuer for charges applied against the line of credit.

A merchant category code (MCC) is a number (e.g., four-digit number) identified in the ISO 18245 standard, which pertains to retail financial services. A merchant category code is assigned to a business to indicate the types of goods and/or services that the business provides (e.g., sells). For instance, a committee of issuers (e.g., MasterCard, Visa, American Express, Diners Club, and Discover) may create the merchant category codes to be used by merchants who use the payment infrastructure of any one or more of the issuers for purchase transactions. A healthcare-related merchant category code is a merchant category code that indicates that the types of goods and/or services that a business provides are healthcare-related goods and/or healthcare-related services. Examples of a healthcare-related merchant category code include but are not limited to the following: “4119” which pertains to ambulance services; “5047” which pertains to dental, lab, medical, and ophthalmic hospital equipment and supplies; “5122” which pertains to drugs, drug proprietaries, and druggists sundries; “5912” which pertains to drug stores and pharmacies; “5975” which pertains to hearing aids sales, service, and supply stores; “5976” which pertains to orthopedic goods and artificial limbs stores; “7277” which pertains to debt, marriage, and personal counseling service; “8011” which pertains to doctors not elsewhere classified; “8021” dentists and orthodontists; “8031” which pertains to osteopathic physicians; “8041” which pertains to chiropractors; “8042” which pertains to optometrists and ophthalmologists; “8043” which pertains to opticians, optical goods, and eyeglasses; “8049” which pertains to chiropodists and podiatrists; “8050” which pertains to nursing and personal care facilities; “8062” which pertains to hospitals; “8071” which pertains to dental and medical laboratories; “8099” which pertains to health practitioners and medical services not elsewhere classified; and “6300” which pertains to insurance sales, underwriting, and premiums. These example healthcare-related merchant category codes are provided for non-limiting illustrative purposes. For example, additional healthcare-related merchant category codes may be identified in the ISO 18245 standard in the future, and the embodiments described herein are intended to encompass such healthcare-related merchant category codes. In another example, a format of the merchant category codes (including the healthcare-related merchant category codes) may change in the future (e.g., to include one or more additional digits), and the embodiments described herein are intended to encompass such format changes.

Example techniques described herein have a variety of benefits as compared to conventional techniques for handling processing of healthcare expenditures. For instance, the example techniques may enable a user to obtain healthcare, by providing a line of credit (e.g., via an employer-sponsored restricted access credit device) from which the related healthcare expenses may be paid, that the user would not have otherwise been able to obtain or that the user would have been required to delay due to a lack of funds. Accordingly, the example techniques may increase health and/or quality of life of the user. The example techniques may facilitate tracking and organization of healthcare-related purchase transactions by providing a restricted-access credit device that is configured to handle requests for all such transactions and that is further configured to not handle (e.g., to deny) requests for non-healthcare-related purchase transactions. Accordingly, the example techniques may increase efficiency of gathering information regarding healthcare-related purchase transactions of the user and/or generating documentation (e.g., tax statement, prescription history, medical procedure history, medical screening or testing history) based on such information.

Using a restricted-access credit device described herein to pay for healthcare-related purchases may increase a rate at which insurance claims related to the healthcare-related purchases are processed. Accordingly, using the restricted-access credit device may reduce an amount of time that is required for the insurance claims to be processed. For instance, the restricted-access credit device may cause information regarding a purchase transaction to be automatically uploaded to a server, which may trigger the server to automatically process an insurance claim associated with the purchase transaction. If a portion (e.g., 50% or all) of the cost of an item that is purchased via the purchase transaction is covered by insurance, the server may reimburse the portion of the cost to a line of credit associated with the restricted-access credit device before a payment related to the purchase transact is due. Accordingly, the user may receive the item without an out-of-pocket expense. The example techniques described herein may provide real-time (e.g., instant) analysis of the user's credit needs, medical needs, etc. to determine whether additional credit is to be added to the line of credit.

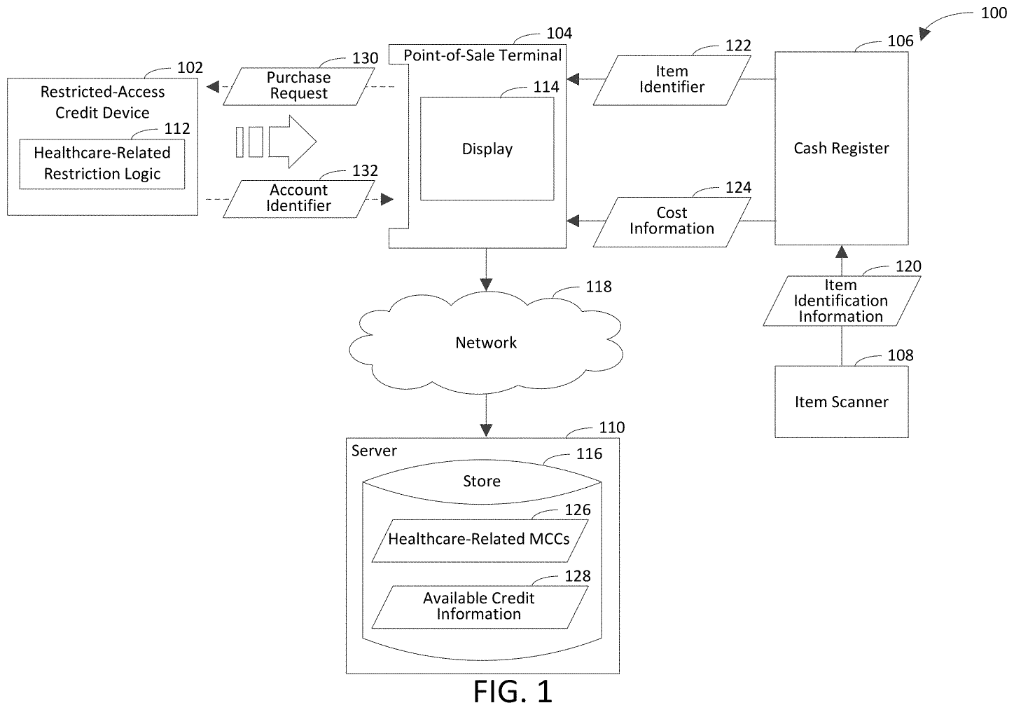

FIG. 1 shows an example restricted-access credit system 100 in accordance with an embodiment. Generally speaking, the restricted-access credit system 100 operates to restrict access to a line of credit associated with a restricted-access credit device 102. As shown in FIG. 1, the restricted-access credit system 100 includes the restricted-access credit device 102, a point-of-sale (POS) terminal 104, a cash register 106, an item scanner 108, a server 110, and a network 118. Communication among the POS terminal 104, the cash register 106, the item scanner 108, and the server 110 may be carried out over the network 118 using well-known network communication protocols. The network 118 may be a wide-area network (e.g., the Internet), a local area network (LAN), another type of network, or a combination thereof. The POS terminal 104 is shown in FIG. 1 to be coupled to the server 110 via the network 118 for non-limiting, illustrative purposes. The cash register 106 is shown to be coupled to the POS terminal 104 and the item scanner 108 without going through the network 118 for non-limiting, illustrative purposes to show that communication therebetween need not necessarily pass through the network 118. Communication between the restricted-access credit device and the POS terminal 104 may be carried out over the network 118 and/or using any other suitable technology (e.g., near-field communication or physical contact). Any of the connections between the POS terminal 104, the cash register 106, the item scanner 108, and the server 110 may be wireless or wired.

The restricted-access credit device 102 is a processing system that is capable of communicating with the POS terminal 104. An example of a processing system is a system that includes at least one processor that is capable of manipulating data in accordance with a set of instructions. For instance, a processing system may be a chip card (e.g., an EMV chip card), a computer, a personal digital assistant, a wearable computer such as a smart watch or a head-mounted computer, a cellular telephone, etc. The processing system may be incorporated into any suitable object, including but not limited to a ring, a necklace, an implantable device, etc. For instance, the implantable device may be implanted beneath the skin of the user to whom the line of credit is granted.

The restricted-access credit device 102 may be configured to communicate with the POS terminal 104 in accordance with the UnifiedPOS (UPOS) standard, which is managed by the Association for Retail Technology Standards (ARTS). A variety of platform-specific implementations of the UnifiedPOS standard exist. One example platform-specific implementation is Object Linking & Embedding (OLE) for Retail POS (OPOS), which was developed for Microsoft Windows® operating systems. The restricted-access credit device and the POS terminal 104 may communicate in accordance with any such implementation of the UPOS standard.

Communication between the restricted-access credit device 102 and the POS terminal 104 may be initiated in any of a variety of ways. For example, the restricted-access credit device 102 may be physically inserted at least partially into the POS terminal 104. In accordance with this example, circuitry in the healthcare-related restriction logic 112 may come into physical contact with conductive leads in the POS terminal 104, thereby establishing a communication channel. For instance, the physical contact may form an electrical contact between the restricted-access credit device 102 and the POS terminal 104. In another example, the restricted-access credit device 102 may be placed within a designated proximity from the POS terminal 104. In accordance with this example, any of a variety of near-field communication protocols may be used to establish a communication channel between the restricted-access credit device 102 and the POS terminal 104. For instance, the communication channel may be established via electrical coupling and/or magnetic coupling.

The restricted-access credit device 102 includes healthcare-related restriction logic 112. The healthcare-related restriction logic 112 is configured to restrict access to the line of credit associated with the restricted-access credit device 102 in accordance with any one or more of the techniques described herein. In an example implementation, the healthcare-related restriction logic 112 communicates with the POS terminal 104 by receiving a purchase request 130 that requests execution of a purchase transaction for an item from the POS terminal 104. The purchase request 130 includes a merchant category code (MCC) of a merchant that is associated with the POS terminal 104. The item includes good(s) and/or service(s). In accordance with this implementation, the healthcare-related restriction logic 112 communicates with the POS terminal 104 further by providing an account identifier 132 that identifies the line of credit associated with the restricted-access credit device 102 to the POS terminal 104.

In one aspect, the account identifier 132 may include a transaction-agnostic account number that identifies the line of credit. A transaction-agnostic account number is an account number that is used for multiple (e.g., all) purchase transactions that are executed using a credit device (e.g., restricted-access credit device 102). Accordingly, in this aspect, the same transaction-agnostic account number may be associated with each purchase transaction that is executed using the restricted-access credit device 102.

In another aspect, the account identifier 132 may include a transaction-specific identifier (e.g., in lieu of the transaction-agnostic account number) that identifies the line of credit. A transaction-specific identifier is an identifier that is used for a single purchase transaction. For instance, a first transaction-specific identifier may identify the line of credit for a first purchase transaction; a second transaction-specific identifier that is different from the first transaction-specific identifier may identify the line of credit for a second purchase transaction; a third transaction-specific identifier that is different from the first and second transaction-specific identifiers may identify the line of credit for a third purchase transaction, and so on. Accordingly, the transaction-specific identifier that is associated with each purchase transaction may uniquely identify that purchase transaction. It will be recognized that a transaction-specific identifier provides greater security than a transaction-agnostic account number.

In further accordance with this implementation, the healthcare-related restriction logic 112 causes the MCC of the merchant to be cross-referenced with healthcare-related MCCs (e.g., healthcare-related MCCs 126). For example, the healthcare-related restriction logic 112 may cross-reference the MCC of the merchant with the healthcare-related MCCs 126. In accordance with this example, the healthcare-related restriction logic 112 may retrieve the healthcare-related MCCs 126 from the server 110 (e.g., via the POS terminal 104) for comparison with the MCC of the merchant. In another example, the healthcare-related restriction logic 112 may instruct the server 110 to cross-reference the MCC of the merchant with the healthcare-related MCCs 126. In accordance with this example, the healthcare-related restriction logic 112 may forward the MCC of the merchant to the server 110 (e.g., via the POS terminal 104) along with an instruction, which instructs the server 110 to cross-reference the MCC of the merchant with the healthcare-related MCCs 126. In further accordance with this example, the healthcare-related restriction logic 112 may receive an indicator from the server 110 that indicates whether the MCC of the merchant corresponds to at least one of the healthcare-related MCCs 126.

In both of the examples mentioned above, the MCC of the merchant corresponding to at least one of the healthcare-related MCCs 126 may indicate that the purchase transaction is to be executed (e.g., execution is to be triggered). Whereas, the MCC of the merchant not corresponding to at least one of the healthcare-related MCCs 126 may indicate that the purchase transaction is not to be executed (e.g., execution is not to be triggered). In one aspect, the MCC of the merchant may correspond to a healthcare-related MCC by semantically matching (i.e., sharing a common meaning with) the healthcare-related MCC. In another aspect, the MCC of the merchant may correspond to a healthcare-related MCC by being the same as the healthcare-related MCC.

In further accordance with this implementation, the healthcare-related restriction logic 112 selectively triggers execution of the purchase transaction depending on (e.g., based at least in part on) whether the MCC of the merchant corresponds to at least one of the healthcare-related MCCs. For example, the healthcare-related restriction logic 112 may trigger execution of the purchase transaction in response to (e.g., based at least in part on) the MCC of the merchant corresponding to at least one of the healthcare-related MCCs 126 by executing the purchase transaction or by instructing the POS terminal 104 to execute the purchase transaction. For instance, the healthcare-related restriction logic 112 may provide an execution instruction to the POS terminal 104 that causes the POS terminal 104 to execute the purchase transaction. In another example, the healthcare-related restriction logic 112 may not trigger execution of the purchase transaction in response to (e.g., based at least in part on) the MCC of the merchant not corresponding to at least one of the healthcare-related MCCs 126 by not executing the purchase transaction and by not instructing the POS terminal 104 to execute the purchase transaction.

In some example embodiments, the healthcare-related restriction logic 112 may selectively trigger execution of the purchase transaction further depending on whether one or more additional criteria are satisfied. For instance, the healthcare-related restriction logic 112 may selectively trigger execution of the purchase transaction further depending on whether the stock keeping unit (SKU) associated with the item corresponds to at least one pre-approved SKU. For example, a pre-approved SKU may be a SKU that is approved prior to the account identifier (e.g., account identifier 132) being provided to the point-of-sale terminal (e.g., POS terminal 104) from which the purchase request is received and prior to the purchase request being received from the point-of-sale.

In an example embodiment, the healthcare-related restriction logic 112 causes the SKU associated with the item to be cross-referenced with pre-approved SKUs. For example, the healthcare-related restriction logic 112 may cross-reference the SKU associated with the item with pre-approved SKUs, which may be stored in a store 116 of the server 110. In accordance with this example, the healthcare-related restriction logic 112 may retrieve the pre-approved SKUs from the server 110 (e.g., via the POS terminal 104) for comparison with the SKU associated with the item. In another example, the healthcare-related restriction logic 112 may instruct the server 110 to cross-reference the SKU associated with the item with the pre-approved SKUs. In accordance with this example, the healthcare-related restriction logic 112 may forward the SKU of the item to the server 110 (e.g., via the POS terminal 104) along with an instruction, which instructs the server 110 to cross-reference the SKU of the item with the pre-approved SKUs. In further accordance with this example, the healthcare-related restriction logic 112 may receive an indicator from the server 110 that indicates whether the SKU of the item corresponds to at least one of the pre-approved SKUs.

In both of the examples mentioned above, the SKU of the item corresponding to at least one of the pre-approved SKUs may indicate that the purchase transaction is to be executed (e.g., execution is to be triggered). Whereas, the SKU of the item not corresponding to at least one of the pre-approved SKUs may indicate that the purchase transaction is not to be executed (e.g., execution is not to be triggered), even if the MCC of the merchant corresponds to at least one of the healthcare-related MCCs 126. In one aspect, the SKU of the item may correspond to a pre-approved SKU by semantically matching (i.e., sharing a common meaning with) the pre-approved SKU. In another aspect, the SKU of the item may correspond to a pre-approved SKU by being the same as the pre-approved SKU.

For example, the healthcare-related restriction logic 112 may trigger execution of the purchase transaction in response to (e.g., based at least in part on) the SKU of the item corresponding to at least one pre-approved SKU and further in response to the MCC of the merchant corresponding to at least one of the healthcare-related MCCs 126 by executing the purchase transaction or by instructing the POS terminal 104 to execute the purchase transaction. In another example, the healthcare-related restriction logic 112 may not trigger execution of the purchase transaction in response to (e.g., based at least in part on) the SKU of the item not corresponding to at least one pre-approved SKU, even if the MCC of the merchant corresponds to at least one of the healthcare-related MCCs 126, by not executing the purchase transaction and by not instructing the POS terminal 104 to execute the purchase transaction.

In some example embodiments, the restricted-access credit device 102 and/or the store 116 may store a policy that identifies the healthcare-related MCCs. The healthcare-related restriction logic 112 may enforce the policy by selectively triggering execution of the purchase transaction depending on whether the MCC of the merchant corresponds to at least one of the healthcare-related MCCs.

The healthcare-related restriction logic 112 may be implemented in various ways to restrict access to the line of credit associated with the restricted-access credit device 102 including being implemented in hardware, software, firmware, or any combination thereof. For example, at least a portion of the healthcare-related restriction logic 112 may be implemented as computer program code configured to be executed in one or more processors. In another example, at least a portion of the healthcare-related restriction logic 112 may be implemented as hardware logic/electrical circuitry. For instance, at least a portion of the healthcare-related restriction logic 112 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

The item scanner 108 is configured to scan an identifier associated with each item that is to be purchased. For instance, the identifier associated with each item may indicate (e.g., include) a SKU. The item scanner 108 is configured to generate item identification information 120 based at least in part on the identifier associated with each item. The item identification information 120 for each item indicates the item or a type of the item. For instance, the identification information may uniquely identify the item or the type of the item. The item identification information 120 may include the identifier or be derived from the identifier. The item scanner 108 may include an optical scanner and/or a tactile scanner.

In an example implementation, the item scanner 108 includes a light source, a lens, and a light sensor. The light source is configured to generate light to illuminate the identifier associated with each item. The lens is configured to direct the light that is reflected from each identifier toward the light sensor. For instance, the lens may focus the light on the light sensor. The light sensor is configured to translate the light that is received from the lens into an electrical signal.

In another example implementation, the identifier associated with each item includes a barcode, and the item scanner 108 includes a barcode scanner that is configured to read each barcode. For instance, the barcode scanner may shine light on each barcode and translate the light that is reflected from the barcode into an electrical signal that represents the item identification information 120. In accordance with this implementation, the item scanner 108 may be capable of decoding data that is included in each barcode to generate the item identification information 120.

The cash register 106 is configured to determine an amount to charge for each item that is to be purchased. For instance, the cash register 106 may cross-reference the item identification information 120 for each item with pre-determined item information associated with respective types of items. For example, the pre-determined item information may be stored in a database, and the cash register 106 may access the database to cross-reference the item identification information 120 for each item with the pre-determined item information associated with the respective types of items. The pre-determined item information for each type of item may identify the type of item and a cost associated with the type of item. For instance, each row of data in the database may correspond to a respective type of item. A first column of data in the database may include identifiers (e.g., names) of the respective types of items with which the respective rows correspond. A second column of data in the database may include per unit costs of the respective types of items with which the respective rows correspond. The cash register 106 may generate the cost information 124 for each item that is to be purchased to indicate the cost associated with the type of the item with which the item identification information 120 for the item corresponds. The cash register 106 may generate the item identifier 122 for each item based at least in part on the item identification information 120 for the respective item. For instance, the item identifier 122 for each item may include the item identification information 120 for the respective item or may be derived from the item identification information 120 for the respective item.

The POS terminal 104 is a processing system that is capable of communicating with the restricted-access credit device 102. The POS terminal 104 is configured to generate the purchase request 130, which includes the MCC of the merchant that is associated with the POS terminal 104. The POS terminal 104 may provide the item identifier 122 or information derived therefrom for each item that is to be purchased to the restricted-access credit device 102, though the scope of the example embodiments is not limited in this respect. The POS terminal 104 includes a display 114, which is configured to display information regarding each item that is to be purchased. For instance, the display 114 may display the item identifier 122 and the corresponding cost information 124 for each item that is to be purchased. The display 114 may further display a cumulative cost for the items that are to be purchased. The POS terminal 104 is configured to generate the purchase request based at least in part on the cumulative cost for the items that are to be purchased and the MCC of the merchant that is associated with the POS terminal 104.

The POS terminal 104 receives the account identifier 132 that identifies the line of credit associated with the restricted-access credit device 102 from the restricted-access credit device 102. The POS terminal 104 selectively applies the cumulative cost against the line of credit depending on (e.g., based at least in part on) whether the restricted-access credit device 102 triggers execution of the purchase transaction. The POS terminal 104 may selectively apply the cumulative cost against the line of credit further depending on whether the available credit associated with the line of credit is greater than or equal to the cumulative cost for the items. For instance, the POS terminal 104 may access (e.g., retrieve) available credit information 128, which indicates the amount of available credit associated with the line of credit, from the server 110 to determine whether the available credit associated with the line of credit is greater than or equal to the cumulative cost for the items. It will be recognized that the POS terminal 104 may include the cash register 106 and/or the item scanner 108, though the scope of the example embodiments is not limited in this respect.

The server 110 includes the store 116, which stores the healthcare-related MCCs 126 and the available credit information 128. The server 110 is configured to provide access to the healthcare-related MCCs 126 and the available credit information 128 in response to request for access that are received from the POS terminal 104. One type of store is a database. For instance, store 116 may be a relational database, an entity-relationship database, an object database, an object relational database, an extensible markup language (XML) database, etc.

It will be recognized that the restricted-access credit system 100 may not include all of the components shown in FIG. 1. Furthermore, the restricted-access credit system 100 may include components in addition to or in lieu of those shown in FIG. 1.

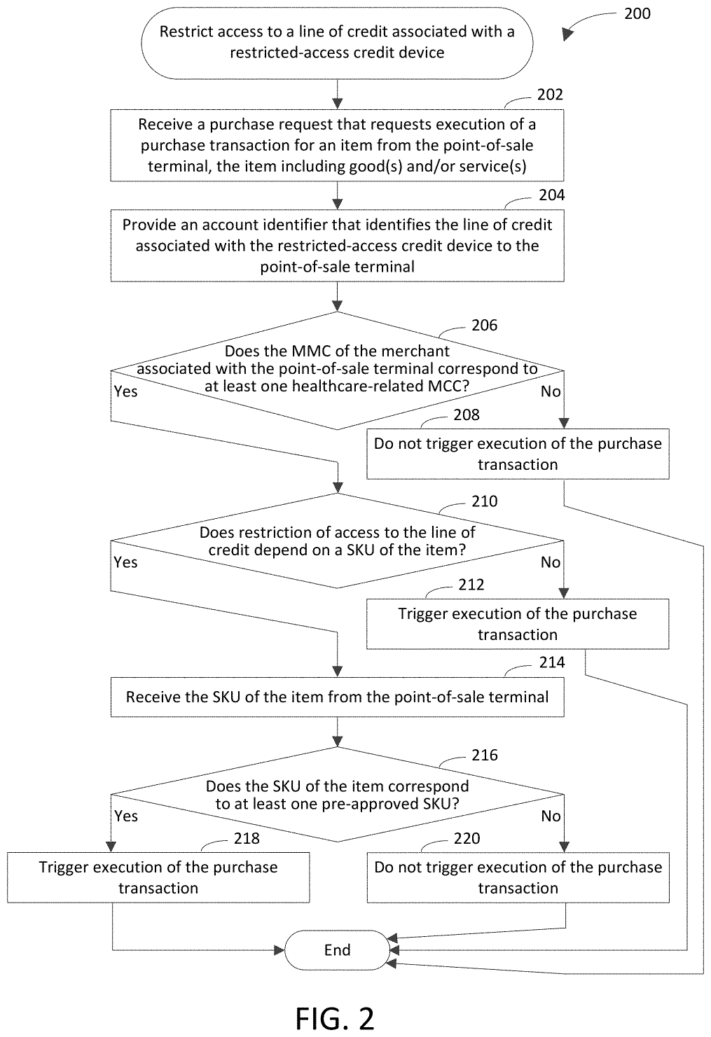

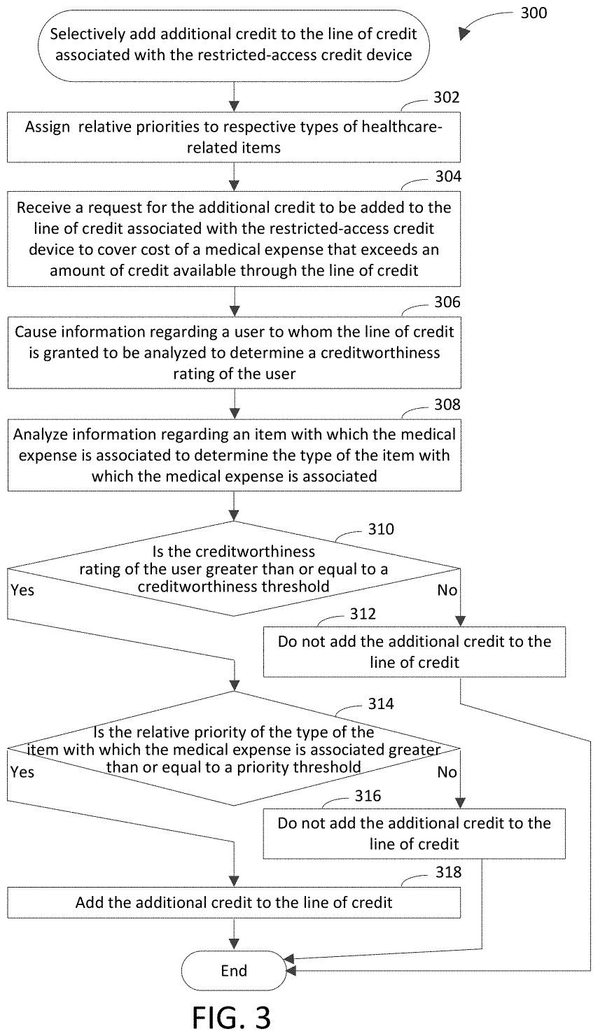

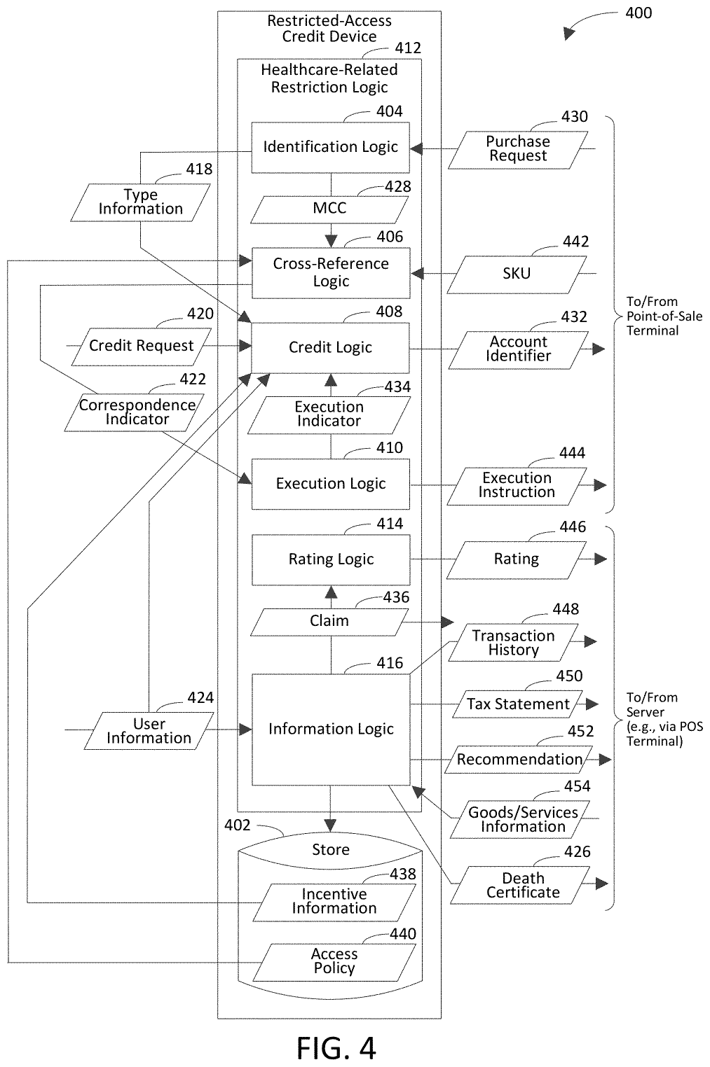

FIG. 2 depicts a flowchart 200 of an example method for restricting access to a line of credit associated with a restricted-access credit device in accordance with an embodiment. FIG. 3 depicts a flowchart 300 of an example method for selectively adding additional credit to a line of credit associated with a restricted-access credit device in accordance with an embodiment. Flowcharts 200 and 300 may be performed by the restricted-access credit device 102 shown in FIG. 1, for example. For illustrative purposes, flowcharts 200 and 300 are described with respect to the restricted-access credit device 400 shown in FIG. 4, which is an example implementation of the restricted-access credit device 102, according to an embodiment. As shown in FIG. 4, the restricted-access credit device 400 includes healthcare-related restriction logic 412 and a store 402. The healthcare-related restriction logic 412 includes identification logic 404, cross-reference logic 406, credit logic 408, execution logic 410, rating logic 414, and information logic 416. Further structural and operational embodiments will be apparent to persons skilled in the relevant art(s) based on the discussion regarding flowcharts 200 and 300.

As shown in FIG. 2, the method of flowchart 200 begins at step 202. In step 202, a purchase request that requests execution of a purchase transaction for an item is received from the point-of-sale terminal. The item includes good(s) and/or service(s). In an example implementation, the identification logic 404 receives a purchase request 430, which requests for the purchase transaction to be executed, from the point-of-sale terminal (e.g., POS terminal 104). In accordance with this example, the identification logic 404 identifies a merchant category code (MCC) 428 of a merchant that is associated with the point-of-sale terminal by analyzing the purchase request 430. The identification logic 404 may provide the MCC 428 of the merchant to the cross-reference logic 406 for processing.

At step 204, an account identifier that identifies the line of credit associated with the restricted-access credit device is provided to the point-of-sale terminal. In an example implementation, the credit logic 408 provides an account identifier 432 that identifies the line of credit associated with the restricted-access credit device 400 to the point-of-sale terminal. For example, the credit logic 408 may provide the account identifier 432 to the point-of-sale terminal in response to receipt of an execution indicator 434 from the execution logic 410. In accordance with this example, the execution indicator 434 may indicate whether the purchase transaction is to be executed. For instance, if the execution indicator 434 indicates that the purchase transaction is to be executed, the credit logic 408 may provide the account identifier 432 to the point-of-sale. If the execution indicator 434 indicates that the purchase transaction is not to be executed, the credit logic 408 may not provide the account identifier 432 to the point-of-sale. In another example, the credit logic 408 may provide the account identifier 432 to the point-of-sale terminal regardless whether the purchase transaction is to be executed.

At step 206, a determination is made whether the MCC of the merchant associated with the point-of-sale terminal corresponds to at least one healthcare-related MCC. If the MCC of the merchant corresponds to at least one healthcare-related MCC, flow continues to step 210. Otherwise, flow continues to step 208. In an example implementation, the cross-reference logic 406 determines whether the MCC 428 of the merchant corresponds to at least one healthcare-related MCC. For instance, the cross-reference logic 406 may cause the MCC 428 of the merchant to be cross-referenced with healthcare-related MCCs to determine whether the MCC 428 of the merchant corresponds to at least one healthcare-related MCC. A store (e.g., the store 402 or a store that is located remotely from the restricted-access credit device 400) may store the healthcare-related MCCs. In one example, the cross-reference logic 406 may access the store to identify the healthcare-related MCCs. In accordance with this example, the cross-reference logic 406 may cross-reference the MCC 428 of the merchant with the healthcare-related MCCs to determine whether the MCC 428 of the merchant corresponds to at least one of the healthcare-related MCCs. In another example, the cross-reference logic 406 may provide an instruction to an entity (e.g., a server) that is external (e.g., located remotely from) the restricted-access credit device. In accordance with this example, the instruction instructs the entity to cross-reference the MCC 428 of the merchant with the healthcare-related MCCs. In further accordance with this example, the cross-reference logic 406 may receive correspondence information from the entity that indicates whether the MCC 428 of the merchant corresponds to at least one of the healthcare-related MCCs. In accordance with this implementation, the cross-reference logic 406 may generate a correspondence indicator 422 to indicate whether the MCC 428 of the merchant corresponds to at least one of the healthcare-related MCCs. For instance, the cross-reference logic 406 may generate the correspondence indicator 422 based on (e.g., based at least in part on) its own cross-referencing of the MCC 428 of the merchant with the healthcare-related MCCs or based on the correspondence information received from the entity.

At step 208, execution of the purchase transaction is not triggered. For example, the purchase transaction may not be triggered based at least in part on the MCC of the merchant not corresponding to at least one healthcare-related MCC. In another example, not triggering execution of the purchase transaction may include denying the request to execute the purchase transaction. Upon completion of step 208, flowchart 200 ends. In an example implementation, the execution logic 410 does not trigger execution of the purchase transaction. For example, the execution logic 410 may not trigger execution of the purchase transaction in response to receipt of the correspondence indicator 422. In accordance with this example, the execution logic 410 may not trigger execution of the purchase transaction based at least in part on the correspondence indicator 422 indicating that the MCC 428 of the merchant does not correspond to at least one of the healthcare-related MCCs.

At step 210, a determination is made whether restriction of access to the line of credit depends on a SKU of the item. If the restriction of the access depends on the SKU of the item, flow continues to step 214. Otherwise, flow continues to step 212. In an example implementation, the cross-reference logic 406 determines whether the restriction of the access to the line of credit depends on a SKU 442 of the item. For example, the store 402 may store an access policy 440 defining how access to the line of credit is to be restricted. The access policy 440 may include rules that dictate whether the restriction of the access to the line of credit depends on the SKU of the item. The cross-reference logic 406 may retrieve the access policy 440 from the store 402 for review. The cross-reference logic 406 may determine whether the restriction of the access to the line of credit depends on the SKU of the item by analyzing the rules in the access policy 440 that define how access to the line of credit is to be restricted. It will be recognized that the cross-reference logic 406 may review the access policy 440 to determine whether the restriction of the access to the line of credit depends on the MCC 428 of the merchant prior to determining whether the MCC 428 of the merchant corresponds to at least one healthcare-related MCC at step 206, though the scope of the example embodiments is not limited in this respect.

At step 212 execution of the purchase transaction is triggered. For example, the purchase transaction may be triggered based at least in part on the MCC of the merchant corresponding to at least one healthcare-related MCC. In accordance with this example, the purchase transaction may be triggered further based at least in part on the restriction of the access to the line of credit not depending on the SKU of the item. Upon completion of step 212, flowchart 200 ends. In an example implementation, the execution logic 410 triggers execution of the purchase transaction. For example, the execution logic 410 may trigger execution of the purchase transaction in response to receipt of the correspondence indicator 422. In accordance with this example, the execution logic 410 may trigger execution of the purchase transaction based at least in part on the correspondence indicator 422 indicating that the MCC 428 of the merchant corresponds to at least one of the healthcare-related MCCs. In further accordance with this example, the execution logic 410 may trigger execution of the purchase transaction further based at least in part on the correspondence indicator 422 indicating that the restriction of the access to the line of credit does not depend on the SKU 442 of the item.

At step 214, the SKU of the item is received from the point-of-sale terminal. The SKU is configured to distinguish an item type of the item from other item types of other items. In an example implementation, the cross-reference logic 406 receives the SKU 442 of the item from the point-of-sale terminal.

At step 216, a determination is made whether the SKU of the item corresponds to at least one pre-approved SKU. For example, each pre-approved SKU may have been pre-approved because it is a healthcare-related SKU. In accordance with this example, SKUs that are healthcare-related may be pre-approved; whereas, SKUs that are not healthcare-related may not be pre-approved. If the SKU of the item corresponds to at least one pre-approved SKU, flow continues to step 218. Otherwise, flow continues to step 220. In an example implementation, the cross-reference logic 406 determines whether the SKU 442 of the item corresponds to at least one pre-approved SKU. For instance, the cross-reference logic 406 may cause the SKU 442 of the item to be cross-referenced with pre-approved SKUs to determine whether the SKU 442 of the item corresponds to at least one pre-approved SKU. A store (e.g., the store 402 or a store that is located remotely from the restricted-access credit device 400) may store the pre-approved SKUs. In one example, the cross-reference logic 406 may access the store to identify the pre-approved SKUs. In accordance with this example, the cross-reference logic 406 may cross-reference the SKU 442 of the item with the pre-approved SKUs to determine whether the SKU 442 of the item corresponds to at least one of the pre-approved SKUs. In another example, the cross-reference logic 406 may provide an instruction to an entity (e.g., a server) that is external (e.g., located remotely from) the restricted-access credit device. In accordance with this example, the instruction instructs the entity to cross-reference the SKU 442 of the item with the pre-approved SKUs. In further accordance with this example, the cross-reference logic 406 may receive correspondence information from the entity that indicates whether the SKU 442 of the item corresponds to at least one of the pre-approved SKUs. In accordance with this implementation, the cross-reference logic 406 may generate a correspondence indicator 422 to indicate whether the SKU 442 of the item corresponds to at least one of the pre-approved SKUs. For instance, the cross-reference logic 406 may generate the correspondence indicator 422 based on (e.g., based at least in part on) its own cross-referencing of the SKU 442 of the item with the pre-approved SKUs or based on the correspondence information received from the entity.

At step 218, execution of the purchase transaction is triggered. For example, the purchase transaction may be triggered based at least in part on the SKU of the item corresponding to at least one pre-approved SKU and further based at least in part on the MCC of the merchant corresponding to at least one healthcare-related MCC. Upon completion of step 218, flowchart 200 ends. In an example implementation, the execution logic 410 triggers execution of the purchase transaction. For example, the execution logic 410 may trigger execution of the purchase transaction in response to receipt of the correspondence indicator 422. In accordance with this example, the execution logic 410 may trigger execution of the purchase transaction based at least in part on the correspondence indicator 422 indicating that the SKU 422 of the item corresponds to at least one pre-approved SKU and further based at least in part on the correspondence indicator 422 indicating that the MCC 428 of the merchant corresponds to at least one of the healthcare-related MCCs.

At step 220, execution of the purchase transaction is not triggered. For instance, the purchase transaction may not be triggered based at least in part on the SKU of the item not corresponding to at least one pre-approved SKU (e.g., even though the MCC of the merchant corresponds to at least one healthcare-related MCC). Upon completion of step 220, flowchart 200 ends. In an example implementation, the execution logic 410 does not trigger execution of the purchase transaction. For example, the execution logic 410 may not trigger execution of the purchase transaction in response to receipt of the correspondence indicator 422. In accordance with this example, the execution logic 410 may not trigger execution of the purchase transaction based at least in part on the correspondence indicator 422 indicating that the SKU 422 of the item does not correspond to at least one pre-approved SKU (e.g., even though the correspondence indicator 422 indicates that the MCC 428 of the merchant corresponds to at least one of the healthcare-related MCCs).

In an example embodiment, the restricted-access credit device is linked to a tax-advantaged health benefit account of a user to whom the line of credit is granted. A tax-advantaged health benefit account is a health benefit account that qualifies for a reduced tax liability, a deferred tax liability (e.g., deferred from a time at which funds are deposited into the health benefit account), or no tax liability. A health benefit account is an account into which tax-reduced, tax-deferred, or tax-free amounts from income of a user are capable of being deposited for purposes of healthcare of the user. Examples of a tax-advantaged health benefit account include but are not limited to a health savings account (HSA), a flexible spending account (FSA), a Medicare account, and a Medicaid account. In accordance with this embodiment, the tax-advantaged health benefit account has funds available for purchases. In an aspect of this embodiment, triggering execution of the purchase transaction at step 212 or step 218 includes causing the funds of the tax-advantaged health benefit account to be applied toward a cost of the item. In accordance with this aspect, triggering execution of the purchase transaction at step 212 or step 218 may further include determining that the cost exceeds the funds by an amount and causing the amount to be applied against the line of credit. Accordingly, the amount may be paid using (e.g., from) the line of credit. In another aspect of this embodiment, triggering execution of the purchase transaction at step 212 or step 218 includes causing the funds of the tax-advantaged health benefit account to be applied toward the cost of the item in monthly installments.

In some example embodiments, one or more steps 202, 204, 206, 208, 210, 212, 214, 216, 218, and/or 220 of flowchart 200 may not be performed. Moreover, steps in addition to or in lieu of steps 202, 204, 206, 208, 210, 212, 214, 216, 218, and/or 220 may be performed. For instance, in an example embodiment, the method of flowchart 200 further includes establishing a communication channel (e.g., a secure communication channel) with the point-of-sale terminal. For instance, the execution logic 410 may establish the communication channel between the restricted-access credit device 400 and the POS terminal 104. In accordance with this embodiment, providing the account identifier at step 204 includes providing the account identifier via the communication channel.

In another example embodiment, execution of the purchase transaction is triggered at step 212 or 218 by causing a cost of the item to be applied against the line of credit. For instance, causing the cost of the item to be applied against the line of credit may include causing the cost to be paid using (e.g., from) the line of credit. In accordance with this embodiment, information regarding an incentive offered by an employer of a user to whom the line of credit is granted may be stored. For instance, the store 402 may store incentive information 438, which includes the information regarding the incentive. The incentive offers a credit based at least in part on a purchase of the item from the merchant that is associated with the point-of-sale terminal rather than from another merchant that offers the item for sale.

In accordance with this embodiment, the credit may be applied to the line of credit, toward an insurance deductible of the user, and/or toward out-of-pocket healthcare expenses of the user based at least in part on the user purchasing the item from the merchant rather than from another merchant that offers the item for sale. In one example, the credit may be a discount (e.g., 5%, 10%, or 15% discount) associated with the item. In another example, the credit is in the form of reward points. For instance, a number of the reward points may be proportional to the cost of the item (e.g., 3 points per dollar of the cost or 5 points per dollar of the cost). The rewards may serve as an incentive for the user to use the restricted-access credit device. The user may donate the rewards to a charitable medical organization.

In yet another example embodiment, the method of flowchart 200 further includes downloading a transaction history, which identifies items purchased with the restricted-access credit device, from a memory that is remote from the restricted-access credit device to the memory that is included in the restricted-access credit device. For instance, the memory from which the transaction history is downloaded may be coupled to the restricted-access credit device through a network. In an example implementation, the information logic 416 downloads transaction history 448, which identifies the items purchased, from the memory that is remote from the restricted-access credit device 400 to the store 402. In an aspect of this embodiment, the method of flowchart 200 further includes preparing (e.g., automatically preparing) an annual tax statement of a user to whom the line of credit is granted based at least in part on the transaction history. For instance, the information logic 416 may prepare a tax statement 450 of the user based at least in part on the transaction history 448.

In still another example embodiment, the method of flowchart 200 further includes providing indemnity up to a designated amount for an ambulance trip, an overnight hospital stay, a disease screening, and/or an emergency room visit based at least in part on payment of a membership fee to use the restricted-access credit device by a user to whom the line of credit is granted. In an example implementation, the credit logic 408 provides the indemnity. For instance, the credit logic 408 may automatically cause the designated amount to be reimbursed to the line of credit in response to the designated amount being applied against the line of credit for the ambulance trip, the overnight hospital stay, the disease screening, and/or the emergency room visit.

In another example embodiment, the method of flowchart 200 further includes providing indemnity up to a first designated amount for an ambulance trip, an overnight hospital stay, a disease screening, and/or an emergency room visit in a first geographic region in which a user to whom the line of credit is granted resides based at least in part on payment of a first membership fee to use the card by the user. In accordance with this embodiment, the method of flowchart 200 further includes providing indemnity up to a second designated amount for the ambulance trip, the overnight hospital stay, the disease screening, and/or the emergency room visit in a second geographic region that is different from the first geographic region based at least in part on payment of a second membership fee that is greater than the first membership fee by the user. In an example implementation, the credit logic 408 provides the indemnity up to the first designated amount in the first geographical region and the indemnity up to the second designated amount in the second geographical region. The of the first and second geographical regions may be a city, state, country, continent, or other suitable geographical region. The first designated amount and the second designated amount may be the same or different.

In yet another example embodiment, the method of flowchart 200 further includes applying an insurance deductible associated with a health insurance policy of a user to whom the line of credit is granted and/or a co-payment associated with the health insurance policy against the line of credit. For instance, the insurance deductible and/or the co-payment may be paid using (e.g., from) the line of credit. In an example implementation, the credit logic 408 applies the insurance deductible and/or the co-payment against the line of credit.

In still another example embodiment, the restricted-access credit device is linked to a tax-advantaged health benefit account of a user to whom the line of credit is granted. In accordance with this embodiment, the method of flowchart 200 includes providing monthly payments from the tax-advantaged health benefit account toward a standing balance resulting from charges applied against the line of credit. In an example embodiment, the credit logic 408 provides the monthly payments from the tax-advantaged health benefit account toward the standing balance.

In another example embodiment, the method of flowchart 200 further includes selecting one or more healthcare-related items, which are to be recommended to a user to whom the line of credit is granted, from healthcare-related items based on any of a variety of factors. Examples of such a factor include but are not limited to a purchasing behavior (e.g., transaction history 448) of the user, a medical history of the user, and a location of the user. For example, the purchasing behavior of the user may indicate healthcare-related items (e.g., products and services) that the user has purchased in the past, a frequency with which each of the healthcare-related items have been purchased, a cost of each of the healthcare-related items, dates on which the healthcare-related items were purchased, and facilities (e.g., pharmacies, emergency centers, hospitals, diagnostic facilities, and wellness clinics) at which the items were purchased. Examples of a healthcare-related product include but are not limited to a book regarding a healthcare-related topic, electronic content (e.g., access to a downloadable file, a computer-readable medium that stores such a file) pertaining to a healthcare-related topic, and a medication. Examples of a healthcare-related service include but are not limited to a medical test, a surgery, a chiropractic treatment, a psychiatric treatment, a dental treatment, and a medical check-up. The medical history of the user may indicate medical tests, surgeries, and check-ups that have been performed on the user, the dates on which they occurred, and the results; medications that the user has taken, dates on which the medications were taken, doses of the medications, mediums through which the medications were taken (e.g., intravenously, orally, topically); medical conditions (e.g., diseases) that the user or the user's family (e.g., ancestors) currently has or has had in the past. The location of the user may be a city, state, and/or country in which the user is presently located or in which the user resides.

In accordance with this embodiment, the information logic 416 may select the one or more healthcare-related items. For example, the information logic 416 may analyze any one or more of the factors mentioned above to determine which of the healthcare-related items to select. In accordance with this example, analysis of the factors may reveal a health issue or potential health issue that may be avoided, mitigated, or resolved by identified healthcare-related item(s). Accordingly, the information logic 416 may select the identified healthcare-related item(s) to be included among the one or more healthcare-related items that are to be recommended to the user.

In further accordance with this embodiment, the one or more healthcare-related items are recommended to the user based at least in part on selection of the one or more healthcare-related items. For instance, the information logic 416 may provide a recommendation 452 to the user that recommends the one or more healthcare-related items. The user may opt-in or opt-out of receiving such recommendations.

In yet another example embodiment, the method of flowchart 200 further includes selecting one or more healthcare-related facilities, which are to be recommended to a user to whom the line of credit is granted, from healthcare-related facilities based at least in part on a quality rating of each of the one or more healthcare-related facilities, a cost of one or more services at each of the one or more healthcare-related facilities, and/or a location of each of the one or more healthcare-related facilities.

In accordance with this embodiment, the information logic 416 may select the one or more health facilities. In accordance with this example, the information logic 416 may analyze goods/services information 454 to determine which of the healthcare-related facilities to select. In a first aspect, the information logic 416 may compare the quality ratings of the respective healthcare-related facilities, as identified in the goods/services information 454, to a quality threshold to determine a first subset of the healthcare-related facilities in which each healthcare-related facility has a quality rating that is greater than or equal to the quality threshold. In a second aspect, the information logic 416 may compare the cost of the one or more services at each of the healthcare-related facilities, as identified in the goods/services information 454, to determine a second subset of the healthcare-related facilities in which each healthcare-related facility offers a cost that is less than or equal to the cost offered by each healthcare-related facility that is not included in the second subset. In accordance with this aspect, the information logic 416 may define the second subset to include approximately a designated percentage of the healthcare-related facilities or to include each healthcare-related facility that offers a cost that is less than or equal to a cost threshold. In a third aspect, the information logic 416 may analyze the goods/services information 454 to determine a location of each of the healthcare-related facilities. In accordance with this aspect, the information logic 416 may determine a distance between a location of the user and a location of each of the healthcare-related facilities. In further accordance with this aspect, the information logic 416 may compare the distances between the location of the user and the respective healthcare-related facilities to a distance threshold to determine a third subset of the healthcare-related facilities such that the distance between the location of the user and the location of each healthcare-related facility in the third subset is less than or equal to the distance threshold.

In further accordance with this embodiment, the method of flowchart 200 further includes recommending the one or more healthcare-related facilities to the user based at least in part on selection of the one or more healthcare-related facilities. For instance, the information logic 416 may recommend the one or more healthcare-related facilities to the user.

In still another example embodiment, the item includes a medical procedure performed on a user to whom the line of credit is granted. In accordance with this embodiment, the method of flowchart 200 further includes causing a claim regarding medical misconduct and/or medical malpractice to be generated on behalf of the user based at least in part on information regarding damages that the user claims to have occurred as a result of the medical procedure, medical data of the user, and/or information regarding the purchase transaction. In an example implementation, the information logic 416 causes a claim 436 regarding medical misconduct and/or medical malpractice to be generated on behalf of the user based at least in part on an analysis of the user information 424 and/or the transaction history 448. For instance, the user information 424 may indicate damages that the user claims to have occurred as a result of the medical procedure. In another example, the user information 424 may include the medical data of the user. In yet another example, the transaction history 448 may include the information regarding the purchase transaction. The information logic 416 may be configured to enable the user to contact an administrator of the restricted-access credit device 400 to notify the administrator of the alleged medical misconduct and/or medical malpractice. The credit logic 408 may be capable of remediating an issue regarding a charge for the item against the line of credit in response to the claim 436 being generated or being resolved in the user's favor.

In accordance with this embodiment, the method of flowchart 200 may further include generating a rating for a medical facility at which the medical procedure is performed and/or a doctor who performed the medical procedure based at least in part on the claim. Accordingly, the rating may be generated to take into consideration the claim. For instance, the rating logic 414 may generate a rating 446 for the medical facility and/or the doctor based at least in part on the claim 436. For instance, if the claim is successful, the rating of the facility and/or the doctor may be reduced by an incremental amount. If the claim is not successful, the rating of the facility and/or the doctor may remain unchanged or may be reduced by an amount that is less than the amount that the rating would have been reduced if the claim had been successful. The rating logic 414 may share the rating 446 with users of other restricted-access credit devices that are offered by a provider that offers the restricted-access credit device 400, though the example embodiments are not limited in this respect.

In another example embodiment, the method of flowchart 200 further includes processing (e.g., automatically processing) a death certificate of a user to whom the line of credit is granted. For example, the information logic 416 may process (e.g., generate) a death certificate 426 of the user. In accordance with this example, the information logic 416 may process the death certificate by analyzing the user information 424 to determine identifying information regarding the user and to determine that the user has died.

In yet another example embodiment, the method of flowchart 200 includes one or more of the steps shown in flowchart 300 of FIG. 3. As shown in FIG. 3, the method of flowchart 300 begins at step 302. In step 302, relative priorities are assigned to respective types of healthcare-related items. In an example implementation, the credit logic 408 assigns the relative priorities to the respective types of healthcare-related items. For instance, the credit logic 408 may assign a first priority to surgical procedures or a specified type of surgical procedure, a second priory to medications or a specified type of medication, a third priority to preventative tests or a specified type of preventative test, and so on. Each of the priorities may be different from the other priorities. The credit logic 408 may store the relative priorities in a store (e.g., the store 402 or a store that is external to the restricted-access credit device 400).

At step 304, a request for the additional credit to be added to the line of credit associated with the restricted-access credit device to cover cost of a medical expense that exceeds an amount of credit available through the line of credit is received. In an example implementation, the credit logic 408 receives a credit request 420 that requests for the additional credit to be added to the line of credit.

At step 306, information regarding a user to whom the line of credit is granted is caused to be analyzed to determine a creditworthiness rating of the user. For example, the information regarding the user may be automatically caused (e.g., in real-time) to be analyzed in response to receipt of the request. In another example, the information regarding the user may include information indicating creditworthiness of the user. In an example implementation, the credit logic 408 causes user information 424, which pertains to the user, to be analyzed to determine the creditworthiness rating of the user. For example, the credit logic 408 may analyze the user information 424. In accordance with this example, the credit logic 408 may retrieve the user information 424 from the store 402 or from a source that is external to the restricted-access credit device 400 for analysis. In another example, the credit logic 408 may instruct an entity that is external to the restricted-access credit device 400 to analyze the user information 424. In accordance with this example, the credit logic 408 may forward the user information 424 to the entity along with an instruction, which instructs the entity to analyze the user information 424 to determine the creditworthiness rating of the user. In further accordance with this example, the credit logic 408 may receive an indicator from the entity that indicates the creditworthiness rating of the user.

At step 308, information regarding an item with which the medical expense is associated is analyzed to determine the type of the item with which the medical expense is associated. In an example implementation, the identification logic 404 analyzes the information regarding the item to determine the type of the item. For instance, the information regarding the item may be included in the purchase request, and the identification logic 404 may review the information therein to determine the type of the item. In accordance with this implementation, the identification logic 404 may generate type information 418 to indicate the type of the item based at least in part on the analysis of the information.

At step 310, a determination is made whether the creditworthiness rating of the user is greater than or equal to a creditworthiness threshold. If the creditworthiness rating of the user is greater than or equal to the creditworthiness threshold, flow continues to 314. Otherwise, flow continues to step 312. In an example implementation, the credit logic 404 determines whether the creditworthiness rating of the user is greater than or equal to the creditworthiness threshold. For instance, may compare the creditworthiness rating of the user to the creditworthiness threshold to make the determination.

At step 312, the additional credit is not added to the line of credit. Upon completion of step 312, flowchart 300 ends. In an example implementation, the credit logic 408 does not add the additional credit to the line of credit (e.g., in response to the creditworthiness rating of the user not being greater than or equal to the creditworthiness threshold).

At step 314, a determination is made whether the relative priority of the type of the item with which the medical expense is associated is greater than or equal to a priority threshold. If the relative priority of the type of the item with which the medical expense is associated is greater than or equal to the priority threshold, flow continues to step 318. Otherwise, flow continues to step 316. In an example implementation, the credit logic 408 determines whether the relative priority of the type of the item is greater than or equal to the priority threshold. For example, the credit logic 408 may cross-reference the type of the item with the various types of healthcare-related items and their assigned relative priorities to determine the relative priority of the type of the item with which the medical expense is associated. In accordance with this example, the credit logic 408 may compare the relative priority of the type of the item with which the medical expense is associated to the priority threshold to determine whether the relative priority of the type of the item with which the medical expense is associated is greater than or equal to the priority threshold.

At step 316, the additional credit is not added to the line of credit. Upon completion of step 316, flowchart 300 ends. In an example implementation, the credit logic 408 does not add the additional credit to the line of credit (e.g., in response to the relative priority of the type of the item with which the medical expense is associated not being greater than or equal to the priority threshold). For instance, the credit logic 408 may not add the additional credit to the line of credit at step 316 even though the creditworthiness rating of the user is greater than or equal to the creditworthiness threshold.

At step 318, the additional credit is added to the line of credit. For instance, the additional credit may be automatically added to the line of credit (e.g., in real-time) in response to the determinations being made at steps 310 and 314. Upon completion of step 318, flowchart 300 ends. In an example implementation, the credit logic 408 adds the additional credit to the line of credit (e.g., in response to the creditworthiness rating of the user being greater than or equal to the creditworthiness threshold and/or in response to the relative priority of the type of the item with which the medical expense is associated being greater than or equal to the priority threshold). The credit logic 408 may add the additional credit to the line of credit with a restriction that the additional credit is to be used for a specified provider and/or a specified event. For instance, if the user requests the additional credit for heart surgery at City Medical Center, the restriction may require that the addition credit be used only for the heart surgery and/or only at the City Medical Center.

In an example embodiment, the information is caused to be analyzed at step 306 further to determine an extent to which the user needs the item with which the medical expense is associated. The extent to which the user needs the item may be measured by an extent to which the item is expected to improve the user's health or an amount of time that the item is expected to add to the user's lifespan. In accordance with this embodiment, the additional credit is added to the line of credit at step 318 based at least in part on the extent to which the user needs the item with which the medical expense is associated exceeding a need threshold.

In some example embodiments, one or more steps 302, 304, 306, 308, 310, 312, 314, 316, and/or 318 of flowchart 300 may not be performed. Moreover, steps in addition to or in lieu of steps 302, 304, 306, 308, 310, 312, 314, 316, and/or 318 may be performed.

It will be recognized that the restricted-access credit device 400 may not include one or more of the store 402, the identification logic 404, the cross-reference logic 406, the credit logic 408, the execution logic 410, the healthcare-related restriction logic 412, the rating logic 414, and/or the information logic 416. Furthermore, the restricted-access credit device 400 may include components in addition to or in lieu of store 402, the identification logic 404, the cross-reference logic 406, the credit logic 408, the execution logic 410, the healthcare-related restriction logic 412, the rating logic 414, and/or the information logic 416.

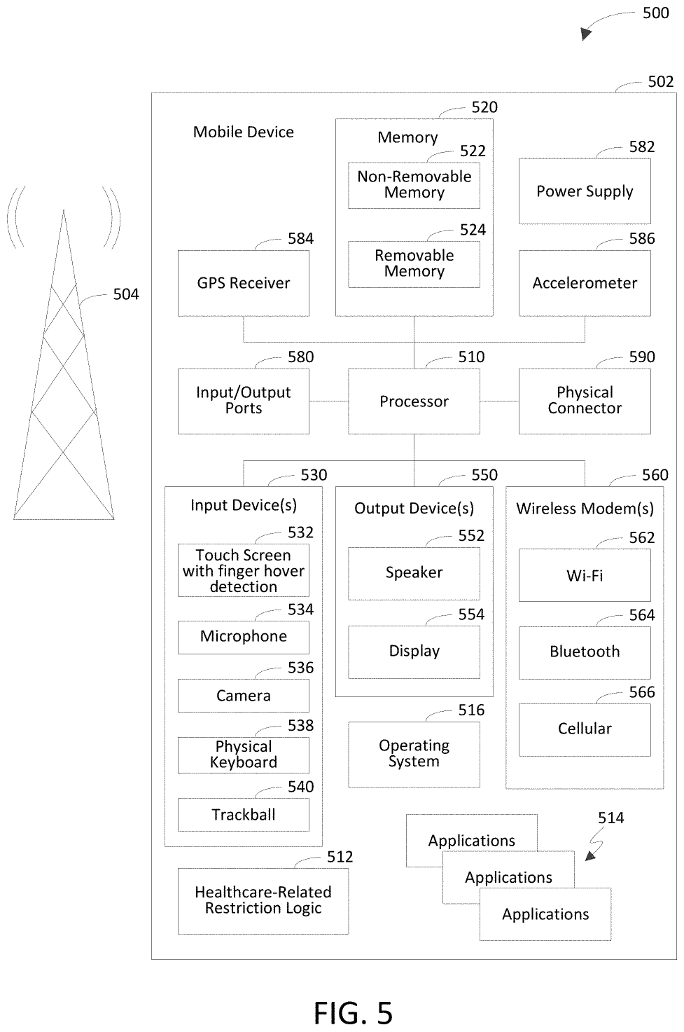

FIG. 5 is a system diagram of an example mobile device 500 including a variety of optional hardware and software components, shown generally as 502. Any components 502 in the mobile device may communicate with any other component, though not all connections are shown, for ease of illustration. The mobile device 500 may be any of a variety of computing devices (e.g., cell phone, smartphone, handheld computer, Personal Digital Assistant (PDA), etc.) and may allow wireless two-way communications with one or more mobile communications networks 504, such as a cellular or satellite network, or with a local area or wide area network.

The mobile device 500 may include a processor 510 (e.g., signal processor, microprocessor, ASIC, or other control and processing logic circuitry) for performing such tasks as signal coding, data processing, input/output processing, power control, and/or other functions. An operating system 516 may control the allocation and usage of the components 502 and support for one or more applications 514 (a.k.a. application programs). The applications 514 may include common mobile computing applications (e.g., email applications, calendars, contact managers, web browsers, messaging applications) and any other computing applications (e.g., word processing applications, mapping applications, media player applications).

The mobile device 500 may include memory 520. The memory 520 may include non-removable memory 522 and/or removable memory 524. The non-removable memory 522 may include RAM, ROM, flash memory, a hard disk, or other well-known memory storage technologies. The removable memory 524 may include flash memory or a Subscriber Identity Module (SIM) card, which is well known in GSM communication systems, or other well-known memory storage technologies, such as “smart cards.” The memory 520 may store data and/or code for running the operating system 516 and the applications 514. Example data may include web pages, text, images, sound files, video data, or other data sets to be sent to and/or received from one or more network servers or other devices via one or more wired or wireless networks. Memory 520 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 500 may support one or more input devices 530, such as a touch screen 532, microphone 534, camera 536, physical keyboard 538 and/or trackball 540 and one or more output devices 550, such as a speaker 552 and a display 554. Touch screens, such as the touch screen 532, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 532 may support a finger hover detection using capacitive sensing, as is well understood in the art. Other detection techniques may be used, including but not limited to camera-based detection and ultrasonic-based detection. To implement a finger hover, a user's finger is typically within a predetermined spaced distance above the touch screen, such as between 0.1 to 0.25 inches, or between 0.0.25 inches and 0.05 inches, or between 0.0.5 inches and 0.75 inches, or between 0.75 inches and 1 inch, or between 1 inch and 1.5 inches, etc.

The mobile device 500 may include healthcare-related restriction logic 512. The healthcare-related restriction logic 512 is configured to restrict access to a line of credit associated with a restricted-access credit device in accordance with any one or more of the techniques described herein.

Other possible output devices (not shown) may include piezoelectric or other haptic output devices. Some devices may serve more than one input/output function. For example, touch screen 532 and display 554 may be combined in a single input/output device. The input devices 530 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 516 or applications 514 may include speech-recognition software as part of a voice control interface that allows a user to operate the mobile device 500 via voice commands. Furthermore, the mobile device 500 may include input devices and software that allows for user interaction via a user's spatial gestures, such as detecting and interpreting gestures to provide input to a gaming application.

Wireless modem(s) 560 may be coupled to antenna(s) (not shown) and may support two-way communications between the processor 510 and external devices, as is well understood in the art. The modem(s) 560 are shown generically and may include a cellular modem 566 for communicating with the mobile communication network 504 and/or other radio-based modems (e.g., Bluetooth 564 and/or Wi-Fi 562). At least one of the wireless modem(s) 560 is typically configured for communication with one or more cellular networks, such as a GSM network for data and voice communications within a single cellular network, between cellular networks, or between the mobile device and a public switched telephone network (PSTN).

The mobile device may further include at least one input/output port 580, a power supply 582, a satellite navigation system receiver 584, such as a Global Positioning System (GPS) receiver, an accelerometer 586, and/or a physical connector 590, which may be a USB port, IEEE 1394 (FireWire) port, and/or RS-232 port. The illustrated components 502 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the identification logic 102, the identification logic 404, the cross-reference logic 406, the credit logic 408, the execution logic 410, the healthcare-related restriction logic 412, the rating logic 414, the information logic 416, flowchart 200, and/or flowchart 300 may be implemented in hardware, software, firmware, or any combination thereof.

For example, any one or more of the identification logic 102, the identification logic 404, the cross-reference logic 406, the credit logic 408, the execution logic 410, the healthcare-related restriction logic 412, the rating logic 414, the information logic 416, flowchart 200, and/or flowchart 300 may be implemented, at least in part, as computer program code configured to be executed in one or more processors.

In another example, any one or more of the identification logic 102, the identification logic 404, the cross-reference logic 406, the credit logic 408, the execution logic 410, the healthcare-related restriction logic 412, the rating logic 414, the information logic 416, flowchart 200, and/or flowchart 300 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Further Discussion of Some Example Embodiments

An example restricted-access credit device comprises memory and one or more processors coupled to the memory. The one or more processors are configured to communicate with a point-of-sale terminal by providing an account identifier that identifies a line of credit associated with the restricted-access credit device to the point-of-sale terminal and further by receiving a purchase request that requests execution of a purchase transaction for an item from the point-of-sale terminal. The purchase request includes a merchant category code of a merchant that is associated with the point-of-sale terminal. The item includes at least one of one or more goods or one or more services. The one or more processors are further configured to cause the merchant category code of the merchant to be cross-referenced with a plurality of healthcare-related merchant category codes. The one or more processors are further configured to selectively trigger execution of the purchase transaction depending on whether the merchant category code of the merchant corresponds to at least one of the healthcare-related merchant category codes.

In a first aspect of the example restricted-access credit device, the one or more processors are configured to communicate with the point-of-sale terminal further by receiving a stock keeping unit (SKU) associated with the item from the point-of-sale terminal. The SKU is configured to distinguish an item type of the item from other item types of other items. In accordance with the first aspect, the one or more processors are configured to selectively trigger execution of the purchase transaction further depending on whether the SKU associated with the item corresponds to at least one of a plurality of pre-approved stock keeping units.

In a second aspect of the example restricted-access credit device, the one or more processors are configured to communicate with the point-of-sale terminal further by receiving a stock keeping unit (SKU) associated with the item from the point-of-sale terminal. The SKU configured to distinguish an item type of the item from other item types of other items. In accordance with the second aspect, the one or more processors are configured to selectively trigger execution of the purchase transaction further depending on whether the SKU is associated with a healthcare-related item. The second aspect of the example restricted-access credit device may be implemented in combination with the first aspect of the example restricted-access credit device, though the example embodiments are not limited in this respect.

In a third aspect of the example restricted-access credit device, the one or more processors are configured to trigger execution of the purchase transaction by causing a cost of the item to be applied against the line of credit based at least in part on the merchant category code of the merchant corresponding to at least one of the healthcare-related merchant category codes. The third aspect of the example restricted-access credit device may be implemented in combination with the first and/or second aspect of the example restricted-access credit device, though the example embodiments are not limited in this respect.

In a first example of the third aspect, the one or more processors are configured to store information regarding an incentive offered by an employer of a user to whom the line of credit is granted. The incentive offers a credit based at least in part on a purchase of the item from the merchant that is associated with the point-of-sale terminal rather than from another merchant that offers the item for sale. In accordance with the first example of the third aspect, the one or more processors are configured to apply the credit to the line of credit based at least in part on the user purchasing the item from the merchant rather than from another merchant that offers the item for sale.

In a second example of the third aspect, the one or more processors are configured to store information regarding an incentive offered by an employer of a user to whom the line of credit is granted, the incentive offering a credit based at least in part on a purchase of the item from the merchant that is associated with the point-of-sale terminal rather than from another merchant that offers the item for sale. In accordance with the second example of the third aspect, the one or more processors are configured to apply the credit toward an insurance deductible associated with a health insurance policy of the user based at least in part on the user purchasing the item from the merchant rather than from another merchant that offers the item for sale.

In a fourth aspect of the example restricted-access credit device, the restricted-access credit device is linked to a tax-advantaged health benefit account of a user to whom the line of credit is granted. The tax-advantaged health benefit account has funds available for purchases. In accordance with the fourth aspect, the one or more processors are configured to apply the funds of the tax-advantaged health benefit account toward a cost of the item and to apply a difference between the cost and the funds against the line of credit. The fourth aspect of the example restricted-access credit device may be implemented in combination with the first, second, and/or third aspect of the example restricted-access credit device, though the example embodiments are not limited in this respect.

In a fifth aspect of the example restricted-access credit device, the one or more processors are configured to download a transaction history, identifying items purchased with the restricted-access credit device, from a memory that is remote from the restricted-access credit device to the memory that is included in the restricted-access credit device. The fifth aspect of the example restricted-access credit device may be implemented in combination with the first, second, third, and/or fourth aspect of the example restricted-access credit device, though the example embodiments are not limited in this respect.

In an example of the fifth aspect, the one or more processors are configured to prepare an annual tax statement of a user to whom the line of credit is granted based at least in part on the transaction history.

In a sixth aspect of the example restricted-access credit device, the one or more processors are configured to store a policy that identifies the plurality of healthcare-related merchant category codes in the memory. In accordance with the sixth aspect, the one or more processors are configured to enforce the policy by selectively triggering execution of the purchase transaction depending on whether the merchant category code of the merchant corresponds to at least one of the healthcare-related merchant category codes. The sixth aspect of the example restricted-access credit device may be implemented in combination with the first, second, third, fourth, and/or fifth aspect of the example restricted-access credit device, though the example embodiments are not limited in this respect.

In a seventh aspect of the example restricted-access credit device, the one or more processors are configured to assign a plurality of relative priorities to a plurality of respective types of healthcare-related items. In accordance with the seventh aspect, the one or more processors are configured to receive a request for additional credit to be added to the line of credit associated with the restricted-access credit device to cover cost of a medical expense that exceeds an amount of credit available through the line of credit. In further accordance with the seventh aspect, the one or more processors are configured to determine whether the additional credit is to be added to the line of credit by causing information regarding a user to whom the line of credit is granted to be analyzed to determine a creditworthiness rating of the user and further by analyzing information regarding an item with which the medical expense is associated to determine the type of the item with which the medical expense is associated. In further accordance with the seventh aspect, the one or more processors are configured to add the additional credit to the line of credit to cover the cost of the medical expense based at least in part on the creditworthiness rating of the user being greater than or equal to a creditworthiness threshold and further based at least in part on the relative priority of the type of the item with which the medical expense is associated being greater than or equal to a priority threshold. The seventh aspect of the example restricted-access credit device may be implemented in combination with the first, second, third, fourth, fifth, and/or sixth aspect of the example restricted-access credit device, though the example embodiments are not limited in this respect.

In an eighth aspect of the example restricted-access credit device, the one or more processors are configured to provide indemnity up to a designated amount for at least one of an ambulance trip, an overnight hospital stay, a disease screening, or an emergency room visit based at least in part on payment of a membership fee to use the restricted-access credit device by a user to whom the line of credit is granted. The eighth aspect of the example restricted-access credit device may be implemented in combination with the first, second, third, fourth, fifth, sixth, and/or seventh aspect of the example restricted-access credit device, though the example embodiments are not limited in this respect.

In a ninth aspect of the example restricted-access credit device, the one or more processors are configured to provide indemnity up to a first designated amount for at least one of an ambulance trip, an overnight hospital stay, a disease screening, or an emergency room visit in a first geographic region in which a user to whom the line of credit is granted resides based at least in part on payment of a first membership fee to use the restricted-access credit device by the user and up to a second designated amount for at least one of the ambulance trip, the overnight hospital stay, the disease screening, or the emergency room visit in a second geographic region that is different from the first geographic region based at least in part on payment of a second membership fee that is greater than the first membership fee by the user. The ninth aspect of the example restricted-access credit device may be implemented in combination with the first, second, third, fourth, fifth, sixth, seventh, and/or eighth aspect of the example restricted-access credit device, though the example embodiments are not limited in this respect.

In a tenth aspect of the example restricted-access credit device, the one or more processors are configured to apply at least one of an insurance deductible associated with a health insurance policy of a user to whom the line of credit is granted or a co-payment associated with the health insurance policy against the line of credit. The tenth aspect of the example restricted-access credit device may be implemented in combination with the first, second, third, fourth, fifth, sixth, seventh, eighth, and/or ninth aspect of the example restricted-access credit device, though the example embodiments are not limited in this respect.

In an eleventh aspect of the example restricted-access credit device, the restricted-access credit device is linked to a tax-advantaged health benefit account of a user to whom the line of credit is granted. In accordance with the eleventh aspect, the one or more processors are configured to provide monthly payments from the tax-advantaged health benefit account toward a standing balance resulting from charges applied against the line of credit. The eleventh aspect of the example restricted-access credit device may be implemented in combination with the first, second, third, fourth, fifth, sixth, seventh, eighth, ninth, and/or tenth aspect of the example restricted-access credit device, though the example embodiments are not limited in this respect.

In a twelfth aspect of the example restricted-access credit device, the one or more processors are configured to select one or more healthcare-related items, which are to be recommended to a user to whom the line of credit is granted, from a plurality of healthcare-related items based at least in part on at least one of a purchasing behavior of the user or a location of the user. In accordance with the twelfth aspect, the one or more processors are configured to recommend the one or more healthcare-related items to the user based at least in part on selection of the one or more healthcare-related items. The twelfth aspect of the example restricted-access credit device may be implemented in combination with the first, second, third, fourth, fifth, sixth, seventh, eighth, ninth, tenth, and/or eleventh aspect of the example restricted-access credit device, though the example embodiments are not limited in this respect.

In a thirteenth aspect of the example restricted-access credit device, the one or more processors are configured to select one or more healthcare-related facilities, which are to be recommended to a user to whom the line of credit is granted, from a plurality of healthcare-related facilities based at least in part on at least one of a quality rating of each of the one or more healthcare-related facilities, a cost of one or more services at each of the one or more healthcare-related facilities, or a location of each of the one or more healthcare-related facilities. In accordance with the thirteenth aspect, the one or more processors are configured to recommend the one or more healthcare-related facilities to the user based at least in part on selection of the one or more healthcare-related facilities. The thirteenth aspect of the example restricted-access credit device may be implemented in combination with the first, second, third, fourth, fifth, sixth, seventh, eighth, ninth, tenth, eleventh, and/or twelfth aspect of the example restricted-access credit device, though the example embodiments are not limited in this respect.

In a fourteenth aspect of the example restricted-access credit device, the item includes a medical procedure performed on a user to whom the line of credit is granted. In accordance with the fourteenth aspect, the one or more processors are configured to cause a claim regarding at least one of medical misconduct or medical malpractice to be generated on behalf of the user based at least in part on information regarding damages that the user claims to have occurred as a result of the medical procedure. The fourteenth aspect of the example restricted-access credit device may be implemented in combination with the first, second, third, fourth, fifth, sixth, seventh, eighth, ninth, tenth, eleventh, twelfth, and/or thirteenth aspect of the example restricted-access credit device, though the example embodiments are not limited in this respect.

In an example of the fourteenth aspect, the one or more processors are configured to generate a rating for at least one of a medical facility at which the medical procedure is performed or a doctor who performed the medical procedure based at least in part on the claim.

In a fifteenth aspect of the example restricted-access credit device, the one or more processors are configured to process a death certificate of a user to whom the line of credit is granted. The fifteenth aspect of the example restricted-access credit device may be implemented in combination with the first, second, third, fourth, fifth, sixth, seventh, eighth, ninth, tenth, eleventh, twelfth, thirteenth, and/or fourteenth aspect of the example restricted-access credit device, though the example embodiments are not limited in this respect.

In an example method of restricting access to a line of credit associated with a restricted-access credit device, communication is performed with a point-of-sale terminal by providing an account identifier that identifies the line of credit associated with the restricted-access credit device to the point-of-sale terminal and further by receiving a purchase request that requests execution of a purchase transaction for an item from the point-of-sale terminal, the item including at least one of one or more goods or one or more services. A merchant category code of a merchant that is associated with the point-of-sale terminal is identified by analyzing the purchase request. The merchant category code of the merchant is caused to be cross-referenced with a plurality of healthcare-related merchant category codes. Execution of the purchase transaction is selectively triggered depending on whether the merchant category code of the merchant corresponds to at least one of the healthcare-related merchant category codes. The selectively triggering execution of the purchase transaction comprises triggering execution of the purchase transaction based at least in part on the merchant category code of the merchant corresponding to at least one of the healthcare-related merchant category codes, or not triggering execution of the purchase transaction based at least in part on the merchant category code of the merchant not corresponding to at least one of the healthcare-related merchant category codes.

In a first aspect of the example method, communicating with the point-of-sale terminal comprises communicating with the point-of-sale terminal further by receiving a stock keeping unit (SKU) associated with the item from the point-of-sale terminal. The SKU is configured to distinguish an item type of the item from other item types of other items. In accordance with the first aspect, selectively triggering execution of the purchase transaction comprises selectively triggering execution of the purchase transaction further depending on whether the SKU associated with the item corresponds to at least one of a plurality of pre-approved stock keeping units.

In a second aspect of the example method, communicating with the point-of-sale terminal comprises communicating with the point-of-sale terminal further by receiving a stock keeping unit (SKU) associated with the item from the point-of-sale terminal. The SKU is configured to distinguish an item type of the item from other item types of other items. In accordance with the second aspect, selectively triggering execution of the purchase transaction comprises selectively triggering execution of the purchase transaction further depending on whether the SKU is associated with a healthcare-related item. The second aspect of the example method may be implemented in combination with the first aspect of the example method, though the example embodiments are not limited in this respect.

In a first example of the second aspect, the example method further comprises storing information regarding an incentive offered by an employer of a user to whom the line of credit is granted, the incentive offering a credit based at least in part on a purchase of the item from the merchant that is associated with the point-of-sale terminal rather than from another merchant that offers the item for sale. In accordance with the first example of the second aspect, the example method further comprises applying the credit to the line of credit based at least in part on the user purchasing the item from the merchant rather than from another merchant that offers the item for sale.

In a second example of the second aspect, the example method further comprises storing information regarding an incentive offered by an employer of a user to whom the line of credit is granted, the incentive offering a credit based at least in part on a purchase of the item from the merchant that is associated with the point-of-sale terminal rather than from another merchant that offers the item for sale. In accordance with the second example of the second aspect, the example method further comprises applying the credit toward an insurance deductible associated with a health insurance policy of the user based at least in part on the user purchasing the item from the merchant rather than from another merchant that offers the item for sale.

In a third aspect of the example method, the restricted-access credit device is linked to a tax-advantaged health benefit account of a user to whom the line of credit is granted. The tax-advantaged health benefit account has funds available for purchases. In accordance with the third aspect, selectively triggering execution of the purchase transaction comprises triggering execution of the purchase transaction by causing the funds of the tax-advantaged health benefit account to be applied toward a cost of the item. The third aspect of the example method may be implemented in combination with the first and/or second aspect of the example method, though the example embodiments are not limited in this respect.

In a fourth aspect of the example method, the example method further comprises downloading a transaction history, which identifies items purchased with the restricted-access credit device, from a memory that is remote from the restricted-access credit device to the memory that is included in the restricted-access credit device. The fourth aspect of the example method may be implemented in combination with the first, second, and/or third aspect of the example method, though the example embodiments are not limited in this respect.

In an example of the fourth aspect, the example method further comprises preparing an annual tax statement of a user to whom the line of credit is granted based at least in part on the transaction history.

In a fifth aspect of the example method, the example method further comprises storing a policy that identifies the plurality of healthcare-related merchant category codes in a memory of the restricted-access credit device. In accordance with the fifth aspect, selectively triggering execution of the purchase transaction comprises enforcing the policy by selectively triggering execution of the purchase transaction depending on whether the merchant category code of the merchant corresponds to at least one of the healthcare-related merchant category codes. The fifth aspect of the example method may be implemented in combination with the first, second, third, fourth, and/or fifth aspect of the example method, though the example embodiments are not limited in this respect.

In a sixth aspect of the example method, the example method further comprises assigning a plurality of relative priorities to a plurality of respective types of healthcare-related items. In accordance with the sixth aspect, the example method further comprises receiving a request for additional credit to be added to the line of credit associated with the restricted-access credit device to cover cost of a medical expense that exceeds an amount of credit available through the line of credit. In further accordance with the sixth aspect, the example method further comprises determining whether the additional credit is to be added to the line of credit by performing operations comprising: causing information regarding a user to whom the line of credit is granted to be analyzed to determine a creditworthiness rating of the user; and analyzing information regarding an item with which the medical expense is associated to determine the type of the item with which the medical expense is associated. In further accordance with the sixth aspect, the example method further comprises adding the additional credit to the line of credit to cover the cost of the medical expense based at least in part on the creditworthiness rating of the user being greater than or equal to a creditworthiness threshold and further based at least in part on the relative priority of the type of the item with which the medical expense is associated being greater than or equal to a priority threshold. The sixth aspect of the example method may be implemented in combination with the first, second, third, fourth, fifth, and/or sixth aspect of the example method, though the example embodiments are not limited in this respect.

In a seventh aspect of the example method, the example method further comprises providing indemnity up to a designated amount for at least one of an ambulance trip, an overnight hospital stay, a disease screening, or an emergency room visit based at least in part on payment of a membership fee to use the restricted-access credit device by a user to whom the line of credit is granted. The seventh aspect of the example method may be implemented in combination with the first, second, third, fourth, fifth, and/or sixth aspect of the example method, though the example embodiments are not limited in this respect.

In an eighth aspect of the example method, the example method further comprises providing indemnity up to a first designated amount for at least one of an ambulance trip, an overnight hospital stay, a disease screening, or an emergency room visit in a first geographic region in which a user to whom the line of credit is granted resides based at least in part on payment of a first membership fee to use the restricted-access credit device by the user. In accordance with the eighth aspect, the example method further comprises providing indemnity up to a second designated amount for at least one of the ambulance trip, the overnight hospital stay, the disease screening, or the emergency room visit in a second geographic region that is different from the first geographic region based at least in part on payment of a second membership fee that is greater than the first membership fee by the user. The eighth aspect of the example method may be implemented in combination with the first, second, third, fourth, fifth, sixth, and/or seventh aspect of the example method, though the example embodiments are not limited in this respect.

In a ninth aspect of the example method, the example method further comprises applying at least one of an insurance deductible associated with a health insurance policy of a user to whom the line of credit is granted or a co-payment associated with the health insurance policy against the line of credit. The ninth aspect of the example method may be implemented in combination with the first, second, third, fourth, fifth, sixth, seventh, and/or eighth aspect of the example method, though the example embodiments are not limited in this respect.

In a tenth aspect of the example method, the restricted-access credit device is linked to a tax-advantaged health benefit account of a user to whom the line of credit is granted. In accordance with the tenth aspect, the example method comprises providing monthly payments from the tax-advantaged health benefit account toward a standing balance resulting from charges applied against the line of credit. The tenth aspect of the example method may be implemented in combination with the first, second, third, fourth, fifth, sixth, seventh, eighth, and/or ninth aspect of the example method, though the example embodiments are not limited in this respect.

In an eleventh aspect of the example method, the example method further comprises selecting one or more healthcare-related items, which are to be recommended to a user to whom the line of credit is granted, from a plurality of healthcare-related items based at least in part on at least one of a purchasing behavior of the user or a location of the user. In accordance with the eleventh aspect, the example method further comprises recommending the one or more healthcare-related items to the user based at least in part on selection of the one or more healthcare-related items. The eleventh aspect of the example method may be implemented in combination with the first, second, third, fourth, fifth, sixth, seventh, eighth, ninth, and/or tenth aspect of the example method, though the example embodiments are not limited in this respect.

In a twelfth aspect of the example method, the example method further comprises selecting one or more healthcare-related facilities, which are to be recommended to a user to whom the line of credit is granted, from a plurality of healthcare-related facilities based at least in part on at least one of a quality rating of each of the one or more healthcare-related facilities, a cost of one or more services at each of the one or more healthcare-related facilities, or a location of each of the one or more healthcare-related facilities. In accordance with the twelfth aspect, the example method further comprises recommending the one or more healthcare-related facilities to the user based at least in part on selection of the one or more healthcare-related facilities. The twelfth aspect of the example method may be implemented in combination with the first, second, third, fourth, fifth, sixth, seventh, eighth, ninth, tenth, and/or eleventh aspect of the example method, though the example embodiments are not limited in this respect.

In an example of the twelfth aspect, the example method further comprises generating a rating for at least one of a medical facility at which the medical procedure is performed or a doctor who performed the medical procedure based at least in part on the claim.

In a thirteenth aspect of the example method, the example method further comprises processing a death certificate of a user to whom the line of credit is granted. The thirteenth aspect of the example method may be implemented in combination with the first, second, third, fourth, fifth, sixth, seventh, eighth, ninth, tenth, eleventh, and/or twelfth aspect of the example method, though the example embodiments are not limited in this respect.

An example computer program product comprises a non-transitory computer-readable medium having computer program logic recorded thereon for enabling a processor-based system to perform operations to restrict access to a line of credit associated with a restricted-access credit device. The operations comprise communicate with a point-of-sale terminal by providing an account identifier that identifies the line of credit associated with the restricted-access credit device to the point-of-sale terminal and further by receiving a purchase request that requests execution of a purchase transaction for an item from the point-of-sale terminal. The purchase request includes a merchant category code of a merchant that is associated with the point-of-sale terminal. The item includes at least one of one or more goods or one or more services. The operations further comprise cause the merchant category code of the merchant to be cross-referenced with a plurality of healthcare-related merchant category codes. The operations further comprise selectively trigger execution of the purchase transaction depending on whether the merchant category code of the merchant corresponds to at least one of the healthcare-related merchant category codes, including: trigger execution of the purchase transaction based at least in part on the merchant category code of the merchant corresponding to at least one of the healthcare-related merchant category codes, or not trigger execution of the purchase transaction based at least in part on the merchant category code of the merchant not corresponding to at least one of the healthcare-related merchant category codes.

### IV. Example Computer System

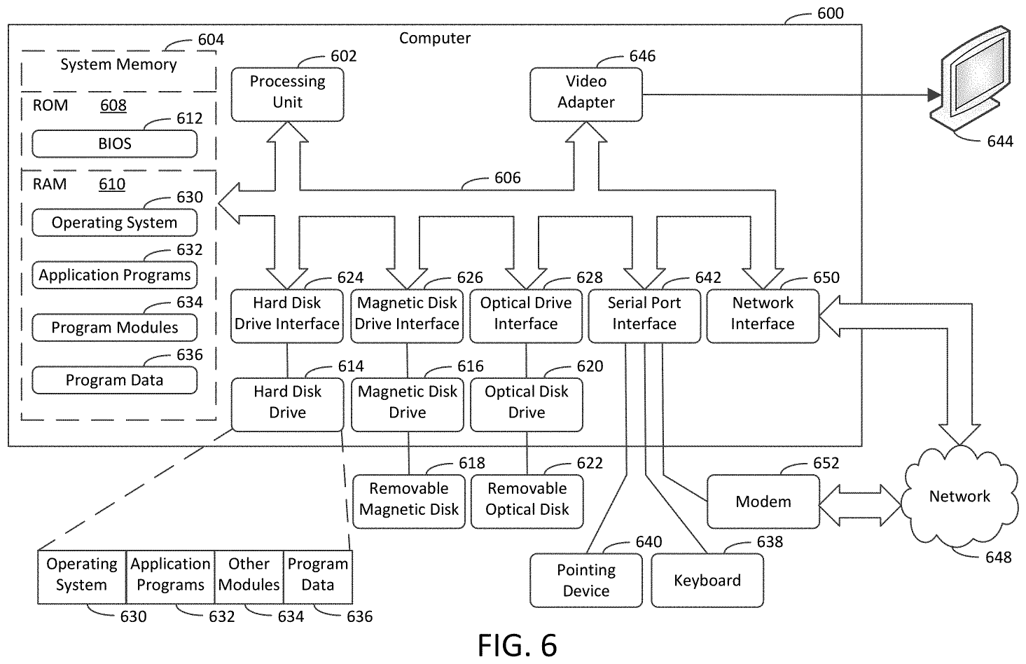

FIG. 6 depicts an example computer 600 in which embodiments may be implemented. The restricted-access credit device 102, the POS terminal 104, the cash register 106, the item scanner 108, the server 110, and/or the restricted-access credit device 400 may be implemented using computer 600, including one or more features of computer 600 and/or alternative features. Computer 600 may be a general-purpose computing device in the form of a conventional personal computer, a mobile computer, or a workstation, for example, or computer 600 may be a special purpose computing device. For instance, computer 600 may be a desktop computer, a laptop computer, a tablet computer, a wearable computer such as a smart watch or a head-mounted computer, a personal digital assistant, a cellular telephone, an Internet of things (IoT) device, or the like. The description of computer 600 provided herein is provided for purposes of illustration, and is not intended to be limiting. Embodiments may be implemented in further types of computer systems, as would be known to persons skilled in the relevant art(s).

As shown in FIG. 6, computer 600 includes a processing unit 602, a system memory 604, and a bus 606 that couples various system components including system memory 604 to processing unit 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system 612 (BIOS) is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, computer program logic for implementing any one or more of the identification logic 102, the identification logic 404, the cross-reference logic 406, the credit logic 408, the execution logic 410, the healthcare-related restriction logic 412, the rating logic 414, the information logic 416, flowchart 200 (including any step of flowchart 200), and/or flowchart 300 (including any step of flowchart 300), as described herein.

A user may enter commands and information into the computer 600 through input devices such as keyboard 638 and pointing device 640. Other input devices (not shown) may include a microphone, joystick, game pad, satellite dish, scanner, touch screen, camera, accelerometer, gyroscope, or the like. These and other input devices are often connected to the processing unit 602 through a serial port interface 642 that is coupled to bus 606, but may be connected by other interfaces, such as a parallel port, game port, or a universal serial bus (USB).

A display device 644 (e.g., a monitor) is also connected to bus 606 via an interface, such as a video adapter 646. In addition to display device 644, computer 600 may include other peripheral output devices (not shown) such as speakers and printers.

Computer 600 is connected to a network 648 (e.g., the Internet) through a network interface or adapter 650, a modem 652, or other means for establishing communications over the network. Modem 652, which may be internal or external, is connected to bus 606 via serial port interface 642.

As used herein, the terms “computer program medium” and “computer-readable storage medium” are used to generally refer to media (e.g., non-transitory media) such as the hard disk associated with hard disk drive 614, removable magnetic disk 618, removable optical disk 622, as well as other media such as flash memory cards, digital video disks, random access memories (RAMs), read only memories (ROM), and the like. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 632 and other program modules 634) may be stored on the hard disk, magnetic disk, optical disk, ROM, or RAM. Such computer programs may also be received via network interface 650 or serial port interface 642. Such computer programs, when executed or loaded by an application, enable computer 600 to implement features of embodiments discussed herein. Accordingly, such computer programs represent controllers of the computer 600.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V. Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A restricted-access credit device comprising:
memory; and
one or more processors coupled to the memory, the one or more processors configured to:
communicate with a point-of-sale terminal by providing an account identifier that identifies a line of credit associated with the restricted-access credit device to the point-of-sale terminal and further by receiving a purchase request that requests execution of a purchase transaction for an item from the point-of-sale terminal, the purchase request including a merchant category code of a merchant that is associated with the point-of-sale terminal, the item including at least one of one or more goods or one or more services;
cause the merchant category code of the merchant to be cross-referenced with a plurality of healthcare-related merchant category codes; and
selectively trigger execution of the purchase transaction depending on whether the merchant category code of the merchant corresponds to at least one of the healthcare-related merchant category codes.

2. The restricted-access credit device of claim 1, wherein the one or more processors are configured to:
communicate with the point-of-sale terminal further by receiving a stock keeping unit (SKU) associated with the item from the point-of-sale terminal, the SKU configured to distinguish an item type of the item from other item types of other items; and
selectively trigger execution of the purchase transaction further depending on whether the SKU associated with the item corresponds to at least one of a plurality of pre-approved stock keeping units.

3. The restricted-access credit device of claim 1, wherein the one or more processors are configured to trigger execution of the purchase transaction by causing a cost of the item to be applied against the line of credit based at least in part on the merchant category code of the merchant corresponding to at least one of the healthcare-related merchant category codes.

4. The restricted-access credit device of claim 3, wherein the one or more processors are configured to:
store information regarding an incentive offered by an employer of a user to whom the line of credit is granted, the incentive offering a credit based at least in part on a purchase of the item from the merchant that is associated with the point-of-sale terminal rather than from another merchant that offers the item for sale; and
apply the credit to the line of credit based at least in part on the user purchasing the item from the merchant rather than from another merchant that offers the item for sale.

5. The restricted-access credit device of claim 3, wherein the one or more processors are configured to:
store information regarding an incentive offered by an employer of a user to whom the line of credit is granted, the incentive offering a credit based at least in part on a purchase of the item from the merchant that is associated with the point-of-sale terminal rather than from another merchant that offers the item for sale; and
apply the credit toward an insurance deductible associated with a health insurance policy of the user based at least in part on the user purchasing the item from the merchant rather than from another merchant that offers the item for sale.

6. The restricted-access credit device of claim 1, wherein the restricted-access credit device is linked to a tax-advantaged health benefit account of a user to whom the line of credit is granted, the tax-advantaged health benefit account having funds available for purchases; and
wherein the one or more processors are configured to apply the funds of the tax-advantaged health benefit account toward a cost of the item and to apply a difference between the cost and the funds against the line of credit.

7. The restricted-access credit device of claim 1, wherein the one or more processors are configured to:
store a policy that identifies the plurality of healthcare-related merchant category codes in the memory; and
enforce the policy by selectively triggering execution of the purchase transaction depending on whether the merchant category code of the merchant corresponds to at least one of the healthcare-related merchant category codes.

8. The restricted-access credit device of claim 1, wherein the one or more processors are configured to:
assign a plurality of relative priorities to a plurality of respective types of healthcare-related items;
receive a request for additional credit to be added to the line of credit associated with the restricted-access credit device to cover cost of a medical expense that exceeds an amount of credit available through the line of credit;
determine whether the additional credit is to be added to the line of credit by causing information regarding a user to whom the line of credit is granted to be analyzed to determine a creditworthiness rating of the user and further by analyzing information regarding an item with which the medical expense is associated to determine the type of the item with which the medical expense is associated; and
add the additional credit to the line of credit to cover the cost of the medical expense based at least in part on the creditworthiness rating of the user being greater than or equal to a creditworthiness threshold and further based at least in part on the relative priority of the type of the item with which the medical expense is associated being greater than or equal to a priority threshold.

9. The restricted-access credit device of claim 1, wherein the one or more processors are configured to apply at least one of an insurance deductible associated with a health insurance policy of a user to whom the line of credit is granted or a co-payment associated with the health insurance policy against the line of credit.

10. The restricted-access credit device of claim 1, wherein the one or more processors are configured to:
select one or more healthcare-related facilities, which are to be recommended to a user to whom the line of credit is granted, from a plurality of healthcare-related facilities based at least in part on at least one of a quality rating of each of the one or more healthcare-related facilities, a cost of one or more services at each of the one or more healthcare-related facilities, or a location of each of the one or more healthcare-related facilities; and
recommend the one or more healthcare-related facilities to the user based at least in part on selection of the one or more healthcare-related facilities.

11. The restricted-access credit device of claim 1, wherein the item includes a medical procedure performed on a user to whom the line of credit is granted; and
wherein the one or more processors are configured to:
cause a claim regarding at least one of medical misconduct or medical malpractice to be generated on behalf of the user based at least in part on information regarding damages that the user claims to have occurred as a result of the medical procedure.

12. The restricted-access credit device of claim 11, wherein the one or more processors are configured to generate a rating for at least one of a medical facility at which the medical procedure is performed or a doctor who performed the medical procedure based at least in part on the claim.

13. The restricted-access credit device of claim 1, wherein the one or more processors are configured to process a death certificate of a user to whom the line of credit is granted.

14. A method of restricting access to a line of credit associated with a restricted-access credit device, the method comprising:
communicating with a point-of-sale terminal by providing an account identifier that identifies the line of credit associated with the restricted-access credit device to the point-of-sale terminal and further by receiving a purchase request that requests execution of a purchase transaction for an item from the point-of-sale terminal, the item including at least one of one or more goods or one or more services;
identifying a merchant category code of a merchant that is associated with the point-of-sale terminal by analyzing the purchase request;
causing the merchant category code of the merchant to be cross-referenced with a plurality of healthcare-related merchant category codes; and
selectively triggering execution of the purchase transaction depending on whether the merchant category code of the merchant corresponds to at least one of the healthcare-related merchant category codes, said selectively triggering execution of the purchase transaction comprising:
triggering execution of the purchase transaction based at least in part on the merchant category code of the merchant corresponding to at least one of the healthcare-related merchant category codes, or
not triggering execution of the purchase transaction based at least in part on the merchant category code of the merchant not corresponding to at least one of the healthcare-related merchant category codes.

15. The method of claim 14, wherein communicating with the point-of-sale terminal comprises:
communicating with the point-of-sale terminal further by receiving a stock keeping unit (SKU) associated with the item from the point-of-sale terminal, the SKU configured to distinguish an item type of the item from other item types of other items; and
wherein selectively triggering execution of the purchase transaction comprises:
selectively triggering execution of the purchase transaction further depending on whether the SKU is associated with a healthcare-related item.

16. The method of claim 14, further comprising:
downloading a transaction history, which identifies items purchased with the restricted-access credit device, from a memory that is remote from the restricted-access credit device to the memory that is included in the restricted-access credit device.

17. The method of claim 16, further comprising:
preparing an annual tax statement of a user to whom the line of credit is granted based at least in part on the transaction history.

18. The method of claim 14, further comprising:
providing indemnity up to a designated amount for at least one of an ambulance trip, an overnight hospital stay, a disease screening, or an emergency room visit based at least in part on payment of a membership fee to use the restricted-access credit device by a user to whom the line of credit is granted.

19. The method of claim 14, further comprising:
providing indemnity up to a first designated amount for at least one of an ambulance trip, an overnight hospital stay, a disease screening, or an emergency room visit in a first geographic region in which a user to whom the line of credit is granted resides based at least in part on payment of a first membership fee to use the restricted-access credit device by the user; and
providing indemnity up to a second designated amount for at least one of the ambulance trip, the overnight hospital stay, the disease screening, or the emergency room visit in a second geographic region that is different from the first geographic region based at least in part on payment of a second membership fee that is greater than the first membership fee by the user.

20. The method of claim 14, wherein the restricted-access credit device is linked to a tax-advantaged health benefit account of a user to whom the line of credit is granted; and
wherein the method comprises:
providing monthly payments from the tax-advantaged health benefit account toward a standing balance resulting from charges applied against the line of credit.

21. The method of claim 14, further comprising:
selecting one or more healthcare-related items, which are to be recommended to a user to whom the line of credit is granted, from a plurality of healthcare-related items based at least in part on at least one of a purchasing behavior of the user or a location of the user; and
recommending the one or more healthcare-related items to the user based at least in part on selection of the one or more healthcare-related items.

22. A computer program product comprising a non-transitory computer-readable medium having computer program logic recorded thereon for enabling a processor-based system to perform operations to restrict access to a line of credit associated with a restricted-access credit device, the operations comprising
communicate with a point-of-sale terminal by providing an account identifier that identifies the line of credit associated with the restricted-access credit device to the point-of-sale terminal and further by receiving a purchase request that requests execution of a purchase transaction for an item from the point-of-sale terminal, the purchase request including a merchant category code of a merchant that is associated with the point-of-sale terminal, the item including at least one of one or more goods or one or more services;
cause the merchant category code of the merchant to be cross-referenced with a plurality of healthcare-related merchant category codes; and
selectively trigger execution of the purchase transaction depending on whether the merchant category code of the merchant corresponds to at least one of the healthcare-related merchant category codes, including:
trigger execution of the purchase transaction based at least in part on the merchant category code of the merchant corresponding to at least one of the healthcare-related merchant category codes, or
not trigger execution of the purchase transaction based at least in part on the merchant category code of the merchant not corresponding to at least one of the healthcare-related merchant category codes.
